(19) United States
(12) Patent Application Publication
(10) Pub. No.: US 2025/0220591 A1
(43) Pub. Date: Jul. 3, 2025

(54) PATH-LOSS DETERMINATION FOR MULTI-TRP OPERATION

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/988,833

(22) Filed: Dec. 19, 2024

Related U.S. Application Data
(60) Provisional application No. 63/617,022, filed on Jan. 2, 2024.
(60) Provisional application No. 63/618,202, filed on Jan. 5, 2024.

(51) Int. Cl. H04W 52/24; H04W 52/14; H04W 76/20

(52) U.S. Cl. CPC H04W 52/242; H04W 52/146; H04W 76/20

(57) ABSTRACT

Methods and apparatuses for path-loss determination for multi-transmit-receive point (TRP) operation. A method performed by a user equipment (UE) includes receiving a first list of one or more path-loss offsets (PLOs) in a radio resource control (RRC) configuration, receiving first information related to a first path-loss (PL), and receiving second information related to a PLO. The method further includes determining the first PL based on the first information; determining the PLO based on the first list and the second information, determining a second PL based on the first PL and the determined PLO; and determining an uplink (UL) power control parameter based on the first PL or the second PL. The first information includes at least a PL reference signal (RS) index.

### CROSS-REFERENCE TO RELATED AND CLAIM OF PRIORITY

The present application claims priority under 35 U.S.C. § 119(e) to U.S. Provisional Patent Application No. 63/617,022 filed on Jan. 2, 2024 and U.S. Provisional Patent Application No. 63/618,202 filed on Jan. 5, 2024, which are hereby incorporated by reference in their entirety.

### TECHNICAL FIELD

The present disclosure relates generally to wireless communication systems and, more specifically, the present disclosure relates to methods and apparatuses for path-loss determination for multi-transmit-receive point (TRP) operation.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to for path-loss determination for multi-TRP operation.

In one embodiment, a user equipment (UE) is provided. The UE includes a transceiver configured to receive, in a radio resource control (RRC) configuration, a first list of one or more path-loss offsets (PLOs); receive first information related to a first path-loss (PL); and receive second information related to a PLO. The UE further includes a processor operably coupled with the transceiver. The processor is configured to determine the first PL based on the first information; determine, based on the first list and the second information, the PLO; determine, based on the first PL and the determined PLO, a second PL; and determine, based on the first PL or the second PL, an uplink (UL) power control parameter. The first information includes at least a PL reference signal (RS) index.

In another embodiment, a base station (BS) is provided. The BS includes a processor and a transceiver operably coupled with the processor. The transceiver is configured to transmit, in a RRC configuration, a first list of one or more PLOs; transmit first information related to a first PL; and transmit second information related to a PLO. The first PL is based on the first information. The PLO is based on the first list and the second information. A second PL is based on the first PL and the PLO. An UL power control parameter is based on the first PL or the second PL. The first information includes at least a PL RS index.

In yet another embodiment, a method performed by a UE is provided. The method includes receiving a first list of one or more PLOs in a RRC configuration, receiving first information related to a first PL, and receiving second information related to a PLO. The method further includes determining the first PL based on the first information; determining the PLO based on the first list and the second information, determining a second PL based on the first PL and the determined PLO; and determining an UL power control parameter based on the first PL or the second PL. The first information includes at least a PL RS index.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example PLO configuration according to embodiments of the present disclosure;

FIG. 8 illustrates a diagram of an example TCI state according to embodiments of the present disclosure;

FIG. 9 illustrates a diagram of an example TCI state according to embodiments of the present disclosure;

FIG. 10 illustrates a diagram of an example PLO indication according to embodiments of the present disclosure; and

FIG. 11 an example method performed by a UE in a wireless communication system according to embodiments of the present disclosure.

### DETAILED DESCRIPTION

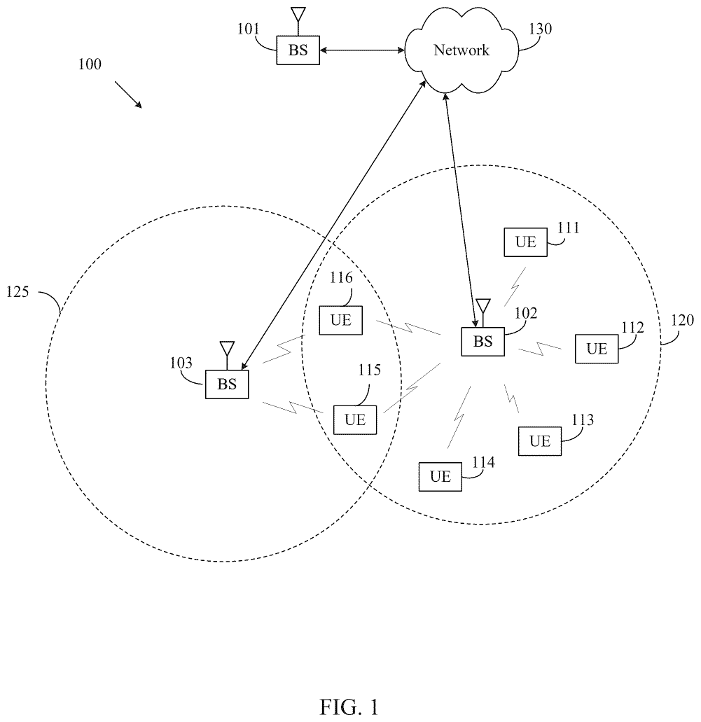

FIGS. 1-11, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1]3GPP TS 38.211 v16.1.0, “NR; Physical channels and modulation;” [2]3GPP TS 38.212 v16.1.0, “NR; Multiplexing and Channel coding;” [3]3GPP TS 38.213 v16.1.0, “NR; Physical Layer Procedures for Control;” [4]3GPP TS 38.214 v16.1.0, “NR; Physical Layer Procedures for Data;” [5]3GPP TS 38.321 v16.1.0, “NR; Medium Access Control (MAC) protocol specification;” and [6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for path-loss determination for multi-TRP operation. In certain embodiments, one or more of the gNBs 101-103 include circuitry, programing, or a combination thereof to support path-loss determination for multi-TRP operation.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

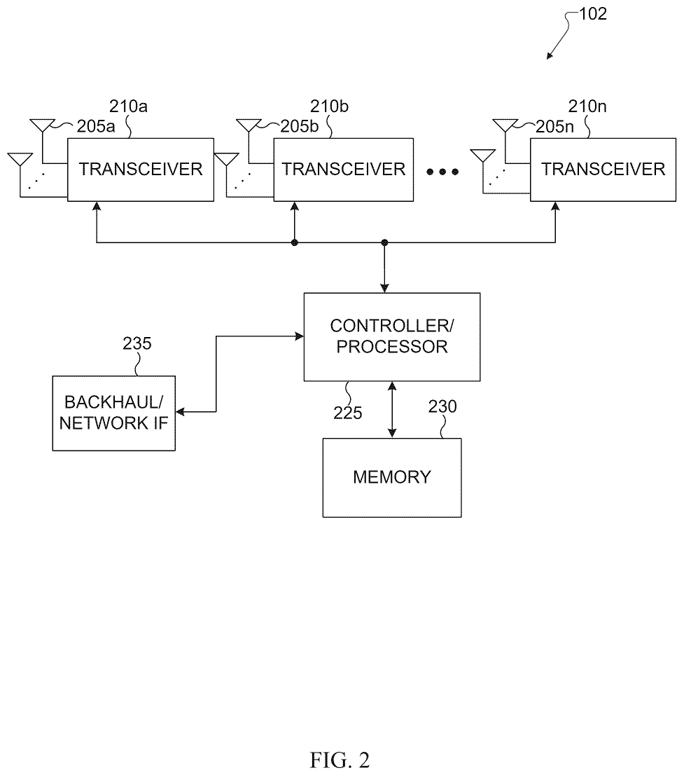

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting path-loss determination for multi-TRP operation. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

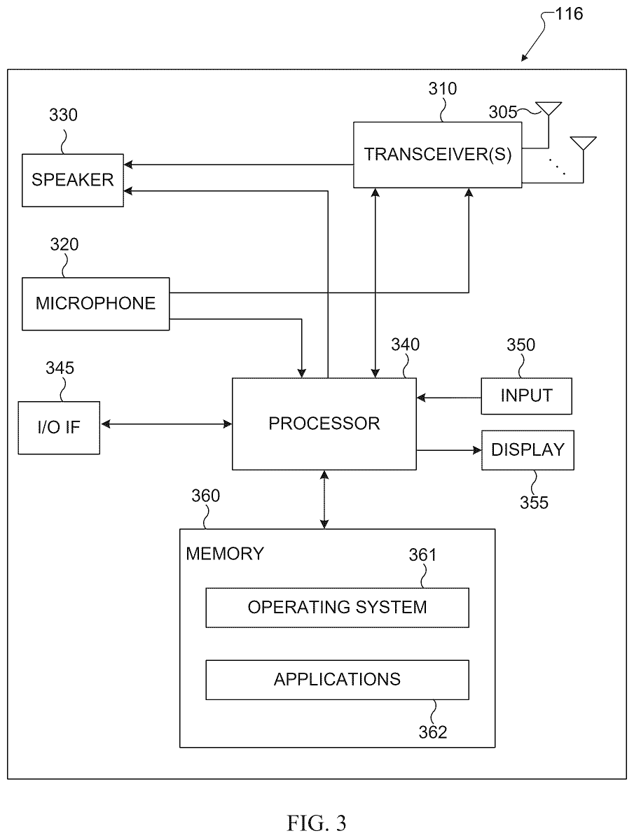

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for path-loss determination for multi-TRP operation as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

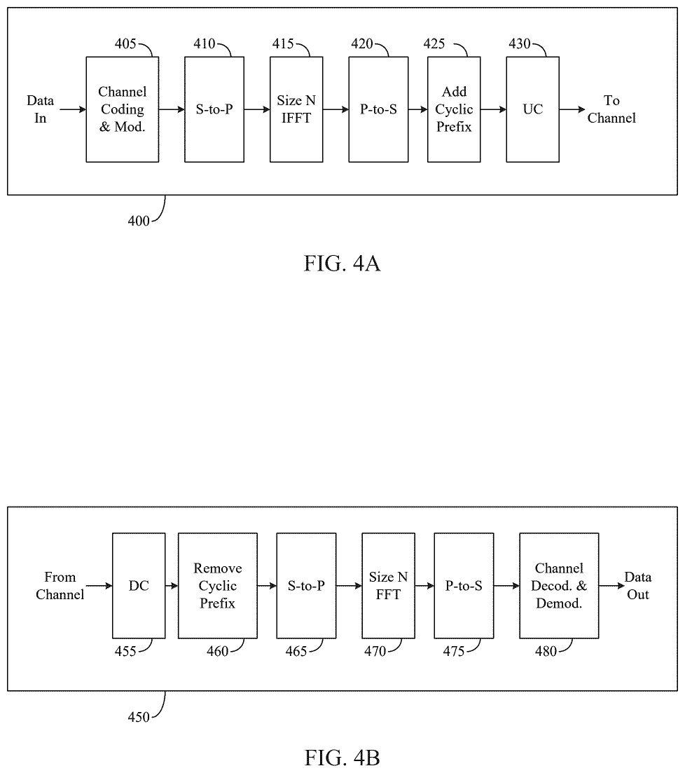

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 perform path-loss determination for multi-TRP operation as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

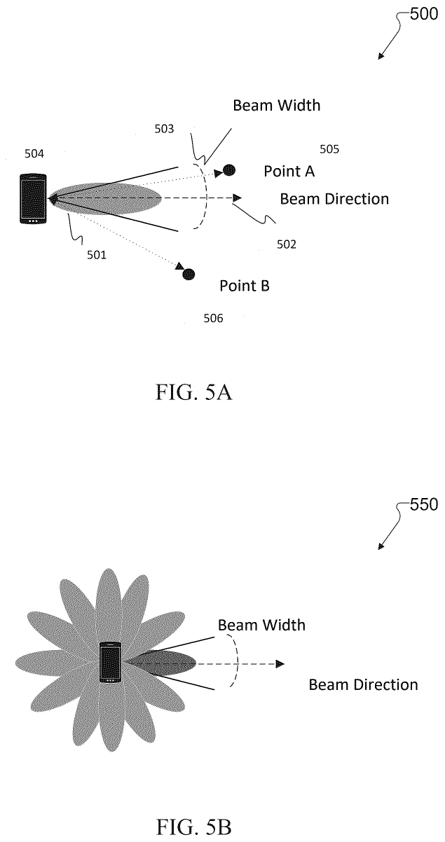

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

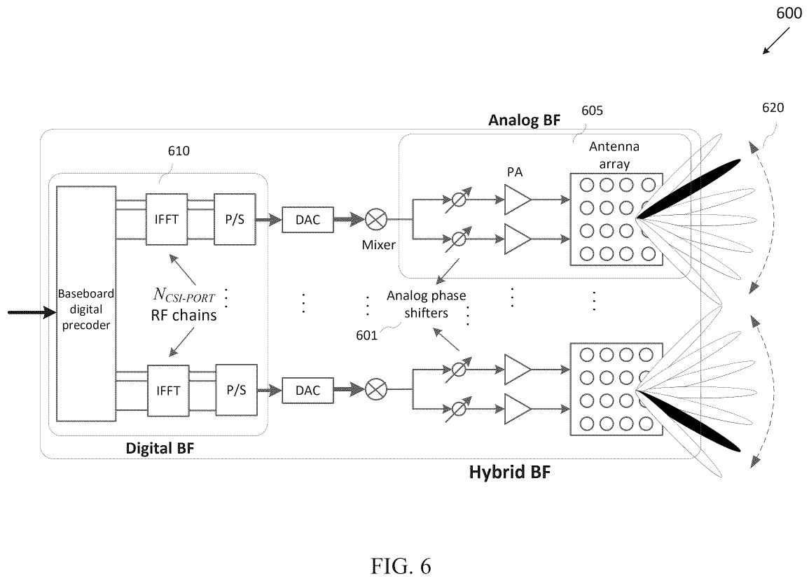

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of,
A TCI state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference reference signal (RS) can determine a spatial Rx filter for reception of downlink channels at the UE, or a spatial TX filter for transmission of uplink channels from the UE.

In Rel-17 NR, a unified TCI framework was specified for single-TRP operation, wherein an indicated joint/DL/UL TCI state can be used for at least UE-dedicated reception(s) of physical downlink control channel (PDCCH) and physical downlink shared channel (PDSCH), and/or transmission(s) of dynamic-grant/configured-grant based physical uplink shared channel (PUSCH) and on dedicated physical uplink control channel (PUCCH) resources. In Rel-18 NR, the unified TCI framework was extended to multi-TRP operation, wherein a UE could respectively use one or both of the two indicated joint/DL/UL TCI states to receive or transmit various DL or UL channels/signals towards or from one or both of the two TRPs.

In a wireless communications system, a UE (e.g., the UE 116) could receive or transmit various DL channels/signals or UL channels/signals from or to a primary network node, and only transmit UL channels/signals to a plurality of secondary network nodes (i.e., the UE would not receive any DL channels and/or signals from the secondary network nodes)—referred to as single-TRP and UL-only multi-TRP operations. For this case/setting, e.g., when the single-TRP and UL-only multi-TRP operations are enabled or triggered or initiated, the UE could obtain path-loss (PL) measurement(s) or estimate(s) for the primary network node by measuring the downlink (DL) PL RS(s) transmitted from the primary network node. However, the UE cannot obtain PL measurement(s) or estimate(s) for the secondary network node(s) by (directly) measuring any DL PL RS(s) from the secondary network node(s). This is because for the evaluated single-TRP and UL-only multi-TRP operations(s), the UE could only transmit to the secondary network node(s) in/via uplink but is not able to receive any DL channel(s) or signal(s) including the PL RS(s) from the secondary network node(s). Hence, embodiments of the present disclosure recognize that means of obtaining the PL measurement(s) for the secondary network node(s) needs to be specified.

This disclosure is focused on PL determination—including PL configuration, activation, indication, measurement and/or estimation—related to the single-TRP and UL-only multi-TRP operations mentioned herein. In particular, this disclosure provides solutions for a UE to estimate PL(s) for the secondary network nodes without directly measuring any DL PL RS(s) from the secondary network nodes. In addition, the TCI framework taken into account throughout the present disclosure is the Rel-17/18 NR unified TCI framework.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC control element (CE) could be used to indicate to the UE a beam (i.e., a TCI state and/or a TCI state ID) for the transmission/reception of a PDCCH or a PDSCH.
In another example, a downlink control information (DCI) could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

A UE could receive from the network (e.g., the network 130) a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of component carriers (CCs)/DL bandwidth parts (BWPs), and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s),
   and/or (2) at least one TCI codepoint activated therein composing/comprising of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and another TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applyIndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentInDCI is configured/present and/or set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s).

That is, for PDSCH reception in a (single-DCI based) multi-TRP system, when a UE is configured with dl-OrJointTCI-StateList and is having two indicated TCI-states, if the UE does not report its capability indicating support of “two default beams for S-DCI based MTRP” in frequency range 2 and when the offset between the reception of the scheduling/activation DCI format 1_0/1_1/1_2 and the scheduled or activated PDSCH reception is less than timeDurationForQCL in frequency range 2, the UE shall apply the first indicated TCI-State to the scheduled or activated PDSCH reception. When a UE (e.g., the UE 116) is configured with dl-OrJointTCJ-StateList and is having two indicated TCI-states:
Regardless of the offset between the reception of the scheduling DCI format 1_0/1_1/1_2 and the scheduled/activated PDSCH reception, if the UE is in frequency range 1, or the UE reports its capability indicating support of “two default beams for S-DCI based MTRP” in frequency range 2, or
If the UE does not report its capability indicating support of “two default beams for S-DCI based MTRP” in frequency range 2 and if the scheduling offset between the reception of the scheduling DCI format 1_0/1_1/1_2 and the scheduled/activated PDSCH reception is equal to or larger than timeDurationForQCL
The UE can be configured by higher layer parameter applylndicatedTCIState to indicate whether the first, the second, or both of the indicated TCI-state(s) is/are applied to PDSCH reception scheduled or activated by DCI format 1_0. The UE can be configured with applylndicatedTCIState with value both only when the UE is configured with cjtSchemePDSCH and the UE reports its capability indicating support of two joint TCI states for PDSCH-CJT or the UE is configured with sfnSchemePdsch. In that case, the UE shall apply both indicated TCI-states to PDSCH reception scheduled or activated by DCI format 1_0 on a search space other than Type/0A/2 common search space (CSS) on CORESET #0.
If the UE is not configured with applylndicatedTCIState, the first indicated TCI-state is applied to PDSCH reception scheduled or activated by DCI format 1_0.
When the UE is configured with tciSelection-PresentInDCI jointly for both DCI formats 1_1 and 1_2 in the same DL BWP, and when the UE receives a DCI format 1_1/1_2 that schedules or activates PDSCH reception, the UE shall determine the indicated joint/DL TCI state(s) for the PDSCH reception according to the following:
If the DCI format 1_1/1_2 indicates codepoint “00” for the TCI selection field (or equivalently, the second indicator as specified herein in the present disclosure), the UE shall apply the first one of two indicated joint/DL TCI states to PDSCH demodulation reference signal (DM-RS) port(s) of corresponding PDSCH transmission occasions(s) scheduled or activated by the DCI format 1_1/1_2.
If the DCI format 1_1/1_2 indicates codepoint “01” for the TCI selection field (or equivalently, the second indicator as specified herein in the present disclosure), the UE shall apply the second one of two indicated joint/DL TCI states to PDSCH DM-RS port(s) of corresponding PDSCH transmission occasion(s) scheduled or activated by the DCI format 1_1/1_2.
If the DCI format 1_1/1_2 indicates codepoint “10” for the TCI selection field (or equivalently, the second indicator as specified herein in the present disclosure), the UE shall apply both indicated joint/DL TCI states to the PDSCH reception scheduled or activated by the DCI format 1_1/1_2.
If the UE is not configured with tciSelection-PresentInDCI and when the UE receives a DCI format 1_1/1_2 that schedules/activates PDSCH reception, the UE shall apply both indicated TCI-States to the scheduled or activated PDSCH reception.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applyIndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting a third indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

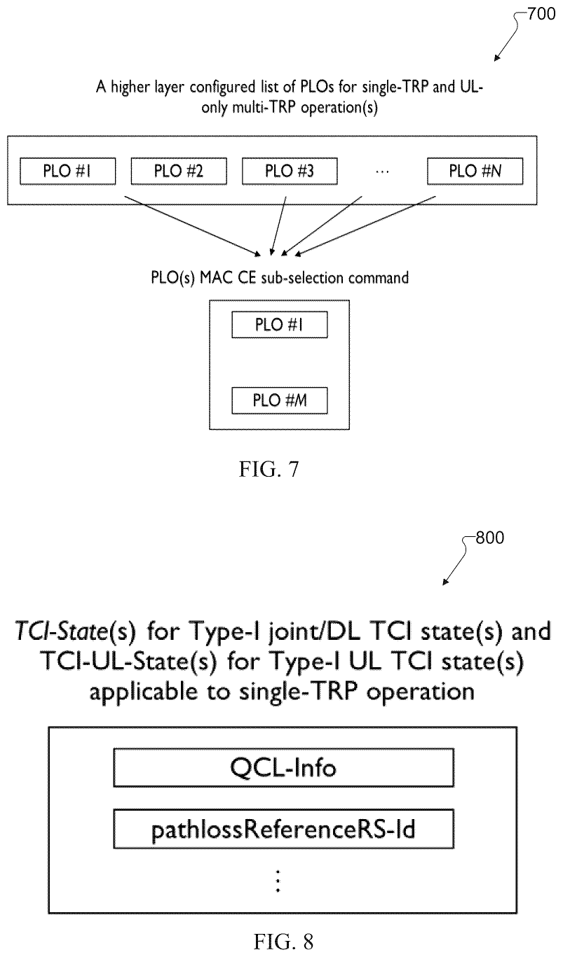

FIG. 7 illustrates a diagram of an example PLO configuration 700 according to embodiments of the present disclosure. For example, PLO configuration 700 can be utilized by any of the UEs 111-116 of FIG. 1, such as the UE 111. This example is for illustration only and other embodiments can be used without departing from the scope of the present disclosure.

A UE could be indicated, configured or provided by the network (e.g., based on or according to a corresponding UE's capability or capability signaling), e.g., via higher layer RRC signaling(s)/parameter(s) and/or MAC CE command(s) and/or dynamic DCI based L1 signaling(s), that the single-TRP and UL-only multi-TRP operation(s) is enabled. When the single-TRP and UL-only multi-TRP operation(s) is enabled as specified herein in the present disclosure, a UE could transmit/receive various UL/DL channels and/or signals to/from a primary network node (i.e., the single-TRP here), and/or only transmit UL channels and/or signals to a plurality of secondary network nodes (i.e., the UL-only MTRP here). Furthermore, a LIE could also indicate or send to the network a capability signaling indicating that the UE is capable of supporting the single-TRP and UL-only multi-TRP operation(s) as specified herein in the present disclosure. For instance, the UE could receive from the network a higher layer parameter enable ULonlyMTRP (e.g., set to ‘enabled’) to enable the single-TRP and UL-only multi-TRP operation(s) as specified herein in the present disclosure, and/or the UE could be (a) higher layer configured with a list of joint/DL TCI states provided by dl-OrJointTCI-StateList and a list of UL TCI states provided by ul-TCI-StateList for the same CC/BWP/serving cell/band and/or (b) higher layer configured with a first value of unifiedTCI-State Type in the serving cell set to joint and a second value of unifiedTCI-State Type in the serving cell set to separate and/or (c) higher layer configured with a value of unifiedTCI-State Type in the serving cell set to separate to enable the single-TRP and UL-only multi-TRP operation(s) as specified herein in the present disclosure and/or (d) higher layer configured with a value of unifiedTCI-State Type in the serving cell set to mixed or mix or bothJointandSeparate to enable the single-TRP and UL-only multi-TRP operation(s) as specified herein in the present disclosure. When the UE is provided/configured/indicated by the network that the single-TRP and UL-only multi-TRP operation(s) is enabled—e.g., when the higher layer parameter enable ULonlyMTRP is provided and/or set to ‘enabled’, and/or when the UE is configured with both dl-OrJointTCI-StateList and ul-TCI-StateList (e.g., for the same CC/BWP/serving cell/band) and/or a first value of unifiedTCI-State Type in the serving cell set to joint and a second value of unifiedTCI-State Type in the serving cell set to separate and/or a value of unifiedTCI-State Type in the serving cell set to separate and/or a value of unifiedTCI-StateType in the serving cell set to mixed or mix or bothJointandSeparate, the UE could be configured/indicated/provided by the network, e.g., via higher layer RRC signaling(s)/parameter(s) and/or MAC CE command(s) and/or dynamic DCI based L1 signaling—e.g., based on or according to one or more corresponding UE's capabilities or capability signaling, one or more lists/sets/pools of path-loss offsets (PLOs) or PLO values—for instance, the UE could be higher layer configured with one or more lists of PLOs each provided by ploList. The UE could also receive from the network one or more PLO(s) activation/deactivation or sub-selection MAC CE commands each activating/deactivating or sub-selecting one or more PLOs from a list of higher layer configured PLOs. Throughout the present disclosure, a PLO or a PLO value could be in dB, and could provide, indicate or correspond to an offset (value) relative to a (reference) path-loss (PL) estimate. For example, for a (reference) PL estimate of x dB and a PLO of y dB (e.g., 0 dB, 1 dB, −1 dB, etc.) relative to the (reference) PL estimate, the UE could determine a (actual) PL estimate as z dB, where z=x+y.

In one embodiment, according to those specified herein in the present disclosure, a UE could be first configured with a list of N≥1 PLOs provided by ploList, wherein N≤Nₘₐₓ. The value(s) of N and/or Nₘₐₓ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals. For this case, the UE could also receive from the network a PLO(s) sub-selection MAC CE command, wherein the PLO(s) sub-selection MAC CE command is to select M≥1 PLOs or PLO indexes (each pointing or corresponding to a PLO value in the list of PLOs) from the list of N higher layer configured PLOs. Here, M≤Mₘₐₓ, and the value(s) of M and/or Mₘₐₓ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals. A conceptual example charactering the described PLO(s) configuration herein and/or activation is presented in FIG. 7.
In one example, the PLO(s) sub-selection MAC CE command could provide or indicate or contain or include or comprise or activate one or more (exact) PLO values and/or PLO indexes with each PLO index pointing/corresponding to an entry or PLO value in the list of higher layer configured PLOs. For this case/setting, the bitwidth of the PLO indexes in the PLO(s) sub-selection MAC CE command could be determined as └log₂N┘.
In another example, the PLO(s) sub-selection MAC CE command could provide or indicate or contain or include or comprise or activate a bitmap of length N with each entry/bit position of the bitmap associated/corresponding to an entry or PLO value in the list of higher layer configured PLOs. When/if an entry/bit position of the bitmap is set to ‘1’ (or ‘0’), the entry or PLO value in the list of higher layer configured PLOs that is associated/corresponding to the entry/bit position of the bitmap could be selected or activated by/in the PLO(s) sub-selection MAC CE command.

Optionally, the UE could receive from the network multiple (e.g., I=2) PLO(s) sub-selection MAC CE commands, wherein the i-th (i.e., i∈{1, . . . , I}) PLO(s) sub-selection MAC CE command is to select Mᵢ≥1 PLOs or PLO indexes (each pointing or corresponding to a PLO value in the list of PLOs) from the list of N higher layer configured PLOs. Here, Mᵢ≤Mₘₐₓ, and the value(s) of Mᵢ and/or Mₘₐₓ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals. Furthermore, the UE could be configured or provided in srs-ResourceSetToAddModList or srs-ResourceSetToAddModListDCI-0-2 with higher layer parameter usage in SRS-ResourceSet set to ‘codebook’ or ‘noncodebook’, two SRS resource sets—denoted by a first SRS resource set and a second SRS resource set. For this case, and for I=2, the first PLO(s) sub-selection MAC CE command (and therefore, the PLOs or PLO indexes provided/selected/activated therein) could be associated/specific to the first (or second) SRS resource set, and the second PLO(s) sub-selection MAC CE command (and therefore, the PLOs or PLO indexes provided/selected/activated therein) could be associated/specific to the second (or first) SRS resource set. For instance, an indicator field (e.g., a new field or by repurposing a ‘R’ reserved field) could be provided or indicated in a PLO(s) sub-selection MAC CE command; the indicator field could correspond to or provide a SRS resource set indicator/index; optionally, the indicator field could correspond to or provide a one-bit indicator—when the one-bit indicator is set to ‘0’ (or ‘1’), the PLO(s) sub-selection MAC CE command could be associated/specific to the first SRS resource set, and/or when the one-bit indicator is set to ‘1’ (or ‘0’), the PLO(s) sub-selection MAC CE command could be associated/specific to the second SRS resource set.
In one example, the i-th PLO(s) sub-selection MAC CE command as specified or defined herein in the present disclosure could provide or indicate or contain or include or comprise or activate one or more (exact) PLO values and/or PLO indexes with each PLO index pointing/corresponding to an entry or PLO value in the list of higher layer configured PLOs. For this case/setting, the bitwidth of the PLO indexes in the i-th PLO(s) sub-selection MAC CE command could be determined as └log₂N┘ or └log₂Mᵢ┘ depending on or according to network's configuration(s)/indication(s)—e.g., via higher layer RRC signaling(s)/parameter(s) and/or MAC CE command(s) and/or dynamic DCI based L1 signaling(s)—e.g., according to or based on a corresponding UE's capability or capability signaling.
In another example, the i-th PLO(s) sub-selection MAC CE command could provide or indicate or contain or include or comprise or activate a bitmap of length N with each entry/bit position of the bitmap associated/corresponding to an entry or PLO value in the list of higher layer configured PLOs. When/if an entry/bit position of the bitmap is set to ‘1’ (or ‘0’), the entry or PLO value in the list of higher layer configured PLOs that is associated/corresponding to the entry/bit position of the bitmap could be selected or activated by/in the i-th PLO(s) sub-selection MAC CE command, wherein the bitmap in the i-th PLO(s) sub-selection MAC CE command could have or provide Mᵢ entries/bit positions set to ‘1’ (or ‘0’) according to those specified herein in the present disclosure.

In one embodiment, according to those specified herein in the present disclosure, a UE could be first configured with multiple (e.g., J=2) lists of PLOs each provided by ploList with a ploListId indicating or providing the index/ID/order of the corresponding list of PLOs, wherein the j-th (i.e., j∈{1, . . . , J} and/or ploListId is set to j) list could contain or include or comprise or provide or configure or indicate Nⱼ≥1 PLOs with Nⱼ≤Nₘₐₓ. The value(s) of Nⱼ and/or Nₘₐₓ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals. Furthermore, the UE could be configured or provided in srs-ResourceSetToAddModList or srs-ResourceSetToAddModListDCI-0-2 with higher layer parameter usage in SRS-ResourceSet set to ‘codebook’ or ‘noncodebook’, two SRS resource sets—denoted by a first SRS resource set and a second SRS resource set. For this case, and for J=2, the first list of N PLOs (e.g., provided by ploList with a ploListId set to ‘1’ or ‘first’) could be associated/specific to the first (or second) SRS resource set, and the second list of N₂ PLOs (e.g., provided by ploList with a ploListId set to ‘2’ or ‘second’) could be associated/specific to the second (or first) SRS resource set. For instance, the higher layer parameter that configures a list of PLOs could provide or configure or include or contain or comprise an indicator; the indicator could correspond to a SRS resource set indicator/index; alternatively, the indicator could correspond to the respective ploListId; optionally, the indicator could correspond to a one-bit indicator—when the one-bit indicator is set to ‘0’ (or ‘1’), the list of PLOs could be associated/specific to the first SRS resource set, and/or when the one-bit indicator is set to ‘1’ (or ‘0’), the list of PLOs could be associated/specific to the second SRS resource set. The UE could also receive from the network a PLO(s) sub-selection MAC CE command, wherein the PLO(s) sub-selection MAC CE command is to select Mⱼ≥1 PLOs or PLO indexes (each pointing or corresponding to a PLO value in the corresponding list of PLOs) from the j-th list of Nⱼ higher layer configured PLOs as defined/specified herein in the present disclosure. Here, Mⱼ≤Mₘₐₓ, and the value(s) of Mⱼ and/or Mₘₐₓ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals.
In one example, the PLO(s) sub-selection MAC CE command could comprise, contain, include, provide, activate or indicate the M₁, M₂, . . . , M_{J} PLOs or PLO indexes in their ordinal positions; for instance, the first M₁ entries/PLOs/PLO indexes in the PLO(s) sub-selection MAC CE command could correspond to the M₁ PLOs or PLO indexes selected from the first list of higher layer configured N₁ PLOs according to those specified herein in the present disclosure, the first M₂ entries/PLOs/PLO indexes succeed to the first M₁ entries/PLOs/PLO indexes in the PLO(s) sub-selection MAC CE command could correspond to the M₂ PLOs or PLO indexes selected from the second list of higher layer configured N₂PLOs according to those specified herein in the present disclosure, and so on, and the last M_{J} entries/PLOs/PLO indexes in the PLO(s) sub-selection MAC CE command could correspond to the M_{J} PLOs or PLO indexes selected from the J-th list of higher layer configured N_{J} PLOs according to those specified herein in the present disclosure. Optionally, the UE could be indicated/configured/provided by the network, e.g., via higher layer RRC signaling(s)/parameter(s) and/or MAC CE command(s) and/or dynamic DCI based L1 signaling—e.g., based on or according to a corresponding UE's capability or capability signaling, the association(s)/mapping(s) between the entries/fields in the PLO(s) sub-selection MAC CE command and the J lists of higher layer configured PLOs—for instance, one or more indicators (e.g., via new indicator field(s) or by repurposing ‘R’ field(s)) could be provided or indicated in the PLO(s) sub-selection MAC CE command each associated/specific to one or more entries/fields in the PLO(s) sub-selection MAC CE command and indicating, providing or informing to the UE from which list(s) of PLOs the PLOs/PLO indexes in the one or more entries/fields are selected or determined. For this case/setting, the bitwidth of the PLO indexes, if indicated/provided, in the PLO(s) sub-selection MAC CE command could be determined as └log₂Σⱼ₌₁^{J}Nⱼ┘, or the bitwidth of the Mⱼ PLO indexes—e.g., associated/specific to the j-th list of higher layer configured PLOs, if indicated/provided, in the PLO(s) sub-selection MAC CE command as specified herein in the present disclosure could be determined as └log₂Nⱼ┘, depending on or according to network's configuration(s)/indication(s)—e.g., via higher layer RRC signaling(s)/parameter(s) and/or MAC CE command(s) and/or dynamic DCI based L1 signaling(s)—e.g., according to or based on a corresponding UE's capability or capability signaling.
In another example, the PLO(s) sub-selection MAC CE command could comprise, contain, include, provide, activate or indicate a bitmap of length Σⱼ₌₁^{J}Nⱼ—i.e., with Σⱼ₌₁^{J} Nⱼ entries/bit positions, wherein each entry/bit position in the bitmap could correspond to a PLO in a list of PLOs among the J lists of PLOs higher layer configured to the UE (e.g., the UE 116) according to those specified herein in the present disclosure. For instance, each of the first N₁ entries/bit positions of the bitmap in the PLO(s) sub-selection MAC CE command could correspond to a PLO value from the first list of higher layer configured N₁ PLOs according to those specified herein in the present disclosure, each of the first N₂ entries/bit positions succeed to the first N₁ entries/bit positions of the bitmap in the PLO(s) sub-selection MAC CE command correspond to a PLO value from the second list of higher layer configured N₂PLOs according to those specified herein in the present disclosure, and so on, and each of the last N_{J} entries/bit positions of the bitmap in the PLO(s) sub-selection MAC CE command could correspond to a PLO value from the J-th list of higher layer configured N_{J} PLOs according to those specified herein in the present disclosure. Optionally, the UE could be indicated/configured/provided by the network, e.g., via higher layer RRC signaling(s)/parameter(s) and/or MAC CE command(s) and/or dynamic DCI based L1 signaling—e.g., based on or according to a corresponding UE's capability or capability signaling, the association(s)/mapping(s) between the entries/bit position of the bitmap in the PLO(s) sub-selection MAC CE command and the J lists of higher layer configured PLOs—for instance, one or more indicators (e.g., via new indicator field(s) or by repurposing ‘R’ field(s)) could be provided or indicated in the PLO(s) sub-selection MAC CE command each associated/specific to one or more entries/bit positions of the bitmap in the PLO(s) sub-selection MAC CE command and indicating, providing or informing to the UE to which list(s) of PLOs the one or more entries/bit positions in the bitmap are associated/specified. For this case, when/if an entry/bit position of the bitmap is set to ‘1’, the entry or PLO value in a corresponding list of higher layer configured PLOs—e.g., among the J lists of higher layer configured PLOs—that is associated/corresponding to the entry/bit position of the bitmap according to those described or specified herein in the present disclosure could be selected or activated by/in the PLO(s) sub-selection MAC CE command.
In another example, the PLO(s) sub-selection MAC CE command could comprise, contain, include, provide, activate or indicate J bitmaps with the j-th bitmap having N_{J} entries/bit positions each corresponding to a PLO value in the j-th list of PLOs as specified herein in the present disclosure. For instance, the first bitmap (and therefore, the corresponding entries/bit positions in the first bitmap) in the PLO(s) sub-selection MAC CE command could be associated/specific to the first list of higher layer configured N₁ PLOs according to those specified herein in the present disclosure, the second bitmap (and therefore, the corresponding entries/bit positions in the second bitmap) in the PLO(s) sub-selection MAC CE command could be associated/specific to the second list of higher layer configured N₂ PLOs according to those specified herein in the present disclosure, and so on, and the J-th bitmap (and therefore, the corresponding entries/bit positions in the J-th bitmap) in the PLO(s) sub-selection MAC CE command could be associated/specific to the J-th list of higher layer configured N_{J} PLOs according to those specified herein in the present disclosure. Optionally, the UE could be indicated/configured/provided by the network (e.g., the network 130), e.g., via higher layer RRC signaling(s)/parameter(s) and/or MAC CE command(s) and/or dynamic DCI based L1 signaling—e.g., based on or according to a corresponding UE's capability or capability signaling, the association(s)/mapping(s) between the J bitmaps in the PLO(s) sub-selection MAC CE command and the J lists of higher layer configured PLOs—for instance, one or more indicators (e.g., via new indicator field(s) or by repurposing ‘R’ field(s)) could be provided or indicated in the PLO(s) sub-selection MAC CE command each associated/specific to one or more bitmaps in the PLO(s) sub-selection MAC CE command and indicating, providing or informing to the UE to which list(s) of PLOs the one or more bitmaps are associated/specified. For this case, when/if an entry/bit position of the j-th bitmap is set to ‘1’, the entry or PLO value in the list of higher layer configured PLOs associated/specific to the j-th bitmap—e.g., the j-th list of higher layer configured PLOs—that is associated/corresponding to the entry/bit position of the j-th bitmap according to those described or specified herein in the present disclosure could be selected or activated by/in the PLO(s) sub-selection MAC CE command.
In another example, one or more indicators could be provided or indicated or included in the PLO(s) sub-selection MAC CE command with each indicator associated to an entry/PLO/PLO index provided or indicated or activated by/in the PLO(s) sub-selection MAC CE command—e.g., the one or more indicators could be indicated or provided by/in new indicator field(s) or by repurposing ‘R’ reserved field(s) in the corresponding PLO(s) sub-selection MAC CE format. Each indicator could indicate or provide or inform to the UE from which list(s) of higher layer configured PLOs the entry/PLO/PLO index in the PLO(s) sub-selection MAC CE command associated to the indicator is selected. For instance, each of the indicators could be set to ‘1’ or ‘2’, . . . , or ‘J’, or ‘first’ or ‘second’, . . . , or ‘J-th’, or could correspond a multi-bit indicator set to ‘0 . . . 0’ or ‘0 . . . 1’, . . . , or ‘1 . . . 1’ to respectively indicate or provide or inform to the UE that the entry/PLO/PLO index in the PLO(s) sub-selection MAC CE command associated to the corresponding indicator could be selected from the first list of N₁ higher layer configured PLOs or the second list of N₂ higher layer configured PLOs, . . . , or the J-th list of N_{J} higher layer configured PLOs. In particular, for J=2, each of the indicators could correspond to a SRS resource set indicator/index; alternatively, each of the indicators could correspond to a ploListId (e.g., set to ‘1’/‘first’ or ‘2’/‘second’); optionally, each of the indicators could correspond to a one-bit indicator—when the one-bit indicator is set to ‘0’ (or ‘1’), the entry/PLO/PLO index in the PLO(s) sub-selection MAC CE command associated to the indicator could be selected from the first list of N, higher layer configured PLOs, and/or when the one-bit indicator is set to ‘1’ (or ‘0’), the entry/PLO/PLO index in the PLO(s) sub-selection MAC CE command associated to the indicator could be selected from the second list of N₂ higher layer configured PLOs.

Optionally, the UE could receive from the network multiple (e.g., J=2) PLO(s) sub-selection MAC CE commands, wherein the j-th (i.e., j∈{1, . . . , J}) PLO(s) sub-selection MAC CE command is to select M₁≥1 PLOs or PLO indexes (each pointing or corresponding to a PLO value in the corresponding list of PLOs) from the j-th list of Nⱼ higher layer configured PLOs. Here, Mⱼ≤Mₘₐₓ, and the value(s) of Mⱼ and/or Mₘₐₓ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals. For this case/setting, the bitwidth of the PLO indexes, if indicated/provided, in the j-th PLO(s) sub-selection MAC CE command could be determined as └log₂ Σⱼ₌₁^{J} Nⱼ┘ or └log₂Nⱼ┘, depending on or according to network's configuration(s)/indication(s)—e.g., via higher layer RRC signaling(s)/parameter(s) and/or MAC CE command(s) and/or dynamic DCI based L1 signaling(s)—e.g., according to or based on a corresponding UE's capability or capability signaling.
In one example, the association(s)/mapping(s) between the multiple PLO(s) sub-selection MAC CE commands and the multiple lists of higher layer configured PLOs could be fixed in system specification(s) and/or per RRC configuration. As described/specified herein in the present disclosure, the multiple PLO(s) sub-selection MAC CE commands and the multiple lists of higher layer configured PLOs could be one-to-one associated/mapped. For instance, the first PLO(s) sub-selection MAC CE command could be associated/specific to the first list of PLOs such that the first PLO(s) sub-selection MAC CE command is to select M₁≥1 PLOs or PLO indexes (each pointing or corresponding to a PLO value in the corresponding list of PLOs) from the first list of N₁ higher layer configured PLOs, the second PLO(s) sub-selection MAC CE command could be associated/specific to the second list of PLOs such that the second PLO(s) sub-selection MAC CE command is to select M₂≥1 PLOs or PLO indexes (each pointing or corresponding to a PLO value in the corresponding list of PLOs) from the second list of N₂ higher layer configured PLOs, and so on, and the J-th PLO(s) sub-selection MAC CE command could be associated/specific to the J-th list of PLOs such that the J-th PLO(s) sub-selection MAC CE command is to select M_{J}≥1 PLOs or PLO indexes (each pointing or corresponding to a PLO value in the corresponding list of PLOs) from the J-th list of N_{J} higher layer configured PLOs. Optionally, the UE could be indicated/configured/provided by the network, e.g., via higher layer RRC signaling(s)/parameter(s) and/or MAC CE command(s) and/or dynamic DCI based L1 signaling—e.g., based on or according to a corresponding UE's capability or capability signaling, the association(s)/mapping(s) between the J PLO(s) sub-selection MAC CE commands and the J lists of higher layer configured PLOs—for instance, one or more indicators (e.g., via new indicator field(s) or by repurposing ‘R’ field(s)) could be provided or indicated in one or more PLO(s) sub-selection MAC CE commands—e.g., among the J PLO(s) sub-selection MAC CE commands—and indicating, providing or informing to the UE to which list(s) of PLOs the one or more PLO(s) sub-selection MAC CE commands are associated/specified.
In another example, each of the multiple PLO(s) sub-selection MAC CE commands could provide, indicate, include, contain or comprise an indicator, wherein the indicator could indicate or provide or inform to the UE from which list(s) of higher layer configured PLOs the PLOs or PLO indexes provided or indicated or activated in the corresponding PLO(s) sub-selection MAC CE command could be selected—e.g., the indicator could be indicated or provided by/in a new indicator field or by repurposing a ‘R’ reserved field in the corresponding PLO(s) sub-selection MAC CE format. For instance, the indicator could be set to ‘1’ or ‘2’, . . . , or ‘J’, or ‘first’ or ‘second’, . . . , or ‘J-th’, or could correspond a multi-bit indicator set to ‘0 . . . 0’ or ‘0 . . . 1’, . . . , or ‘1 . . . 1’ to respectively indicate or provide or inform to the UE that the PLOs or PLO indexes provided or indicated or activated in the corresponding PLO(s) sub-selection MAC CE command could be selected from the first list of N₁ higher layer configured PLOs or the second list of N₂ higher layer configured PLOs, . . . , or the J-th list of N_{J} higher layer configured PLOs. In particular, for J=2, the indicator in a PLO(s) MAC CE sub-selection command could correspond to a SRS resource set indicator/index; alternatively, the indicator in a PLO(s) MAC CE sub-selection command could correspond to a ploListId (e.g., set to ‘1’/‘first’ or ‘2’/‘second’); optionally, the indicator in a PLO(s) MAC CE sub-selection command could correspond to a one-bit indicator—when the one-bit indicator is set to ‘0’ (or ‘1’), the PLOs or PLO indexes in the PLO(s) sub-selection MAC CE command could be selected from the first list of N₁ higher layer configured PLOs, and/or when the one-bit indicator is set to ‘1’ (or ‘0’), the PLOs or PLO indexes in the PLO(s) sub-selection MAC CE command could be selected from the second list of N₂ higher layer configured PLOs.
In another example, the j-th PLO(s) sub-selection MAC CE command could comprise, contain, include, provide, activate or indicate a bitmap of length Nₕ—i.e., with Nⱼ entries/bit positions, wherein each entry/bit position in the bitmap could correspond to a PLO value in the j-th list of PLOs as specified herein in the present disclosure. For instance, the bitmap (and therefore, the corresponding entries/bit positions in the first bitmap) in the first PLO(s) sub-selection MAC CE command could be associated/specific to the first list of higher layer configured N, PLOs according to those specified herein in the present disclosure, the bitmap (and therefore, the corresponding entries/bit positions in the second bitmap) in the second PLO(s) sub-selection MAC CE command could be associated/specific to the second list of higher layer configured N₂ PLOs according to those specified herein in the present disclosure, and so on, and the bitmap (and therefore, the corresponding entries/bit positions in the bitmap) in the J-th PLO(s) sub-selection MAC CE command could be associated/specific to the J-th list of higher layer configured N_{J} PLOs according to those specified herein in the present disclosure. Optionally, the UE could be indicated/configured/provided by the network, e.g., via higher layer RRC signaling(s)/parameter(s) and/or MAC CE command(s) and/or dynamic DCI based L1 signaling—e.g., based on or according to a corresponding UE's capability or capability signaling, the association(s)/mapping(s) between the J bitmaps in the J PLO(s) sub-selection MAC CE commands and the J lists of higher layer configured PLOs—for instance, one or more indicators (e.g., via new indicator field(s) or by repurposing ‘R’ field(s)) could be provided or indicated in one or more PLO(s) sub-selection MAC CE commands—e.g., among the J PLO(s) sub-selection MAC CE commands—and indicating, providing or informing to the UE to which list(s) of PLOs the one or more PLO(s) sub-selection MAC CE commands (and therefore, the bitmaps indicated/provided therein) are associated/specified. For this case, when/if an entry/bit position of the bitmap in the j-th PLO(s) sub-selection MAC CE command is set to ‘1’, the entry or PLO value in the list of higher layer configured PLOs associated/specific to the bitmap in the j-th PLO(s) sub-selection MAC CE command—e.g., the j-th list of higher layer configured PLOs—that is associated/corresponding to the entry/bit position of the bitmap in the j-th PLO(s) sub-selection MAC CE command according to those described or specified herein in the present disclosure could be selected or activated by/in the j-th PLO(s) sub-selection MAC CE command.

In one embodiment, according to those specified herein in the present disclosure, a UE could be first configured with a first list of PLOs provided by ploList with a ploListId set to ‘1’ or ‘first’, wherein the first list could contain or include or comprise or provide or configure or indicate N₁≥1 PLOs with N₁≤Nₘₐₓ. The value(s) of N₁ and/or Nₘₐₓ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling.
In one example, the UE could be further configured or provided with, e.g., via/by higher layer RRC signaling(s) and/or MAC CE command(s) and/or dynamic DCI based L1 signaling(s), e.g., based on a corresponding UE's capability or capability signaling, J−1 (e.g., J≥1 or J=2) PLO differential values (e.g., in dBs) denoted by d₁, . . . , d_{J-1} for a second list of N₂≥1 PLOs, . . . , a J-th list of N_{J}≥1 PLOs, respectively. The value(s) of Nⱼ≤Nₘₐₓ (j=2, . . . , J for this case/setting) could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling. Denote the PLO values in the first list by a₁, a₂, . . . , a_{N1}. The UE could then determine or identify the PLO values in the second list, . . . , the J-th list (e.g., the first, . . . , the J-th could be based on the ordinal positions/orderings—i.e., the first, . . . , the J-th—of the PLO differential values in their respective higher layer parameter(s)/configuration(s)/signaling(s)) as {a₁±d₁, a₂±d₁, . . . , a_{N2}±d₁}, . . . , {a₁±d_{J-1}, a₂±d_{J-1}, . . . , a_{N┘}±d_{J-1}}, wherein whether to ‘+’ or ‘−’ the corresponding PLO differential value(s) could be based on or according to network's configuration(s)/indication(s)—e.g., via/by higher layer RRC signaling(s)/parameter(s) and/or MAC CE command(s) and/or dynamic DCI based L1 signaling(s)—e.g., based on or according to a corresponding UE's capability or capability signaling. For J=2, in addition to the first list of higher layer configured N₁≥1 PLOs, the UE could determine or identify a second list of PLOs of {a₁±d₁, a₂±d₁, . . . , a_{N2}±d₁}.
In another example, the UE could be further configured or provided with, e.g., via/by higher layer RRC signaling(s) and/or MAC CE command(s) and/or dynamic DCI based L1 signaling(s), e.g., based on a corresponding UE's capability or capability signaling, J−1 (e.g., J≥1 or J=2) lists of PLO differential values with each list providing or comprising Nⱼ≤Nₘₐₓ (j=2, . . . , J for this case/setting) PLO differential values denoted by {d_{j,1}, d_{j,2}, . . . , d_{j,Nj}} in dBs. The value(s) of Nⱼ≤Nₘₐₓ (j=2, . . . , J for this case/setting) could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling. Denote the PLO values in the first list by a₁, a₂, . . . , a_{N1}. The UE could then determine or identify the PLO values in the second list, . . . , the J-th list (e.g., the first, . . . , the J-th could be based on the ordinal positions/orderings—i.e., the first, . . . , the J-th—of the configured lists of PLO differential values in their respective higher layer parameter(s)/configuration(s)/signaling(s)) as {a₁±d_{1,1}, a₂±d_{1,2}, . . . , a_{N2}±d_{1,N2}}, . . . , {a₁±d_{J-1,1}, a₂±d_{J-1,2}, . . . , a_{NJ}±d_{J-1, NJ}}, wherein whether to ‘+’ or ‘−’ the corresponding PLO differential value(s) could be based on or according to network's configuration(s)/indication(s)—e.g., via/by higher layer RRC signaling(s)/parameter(s) and/or MAC CE command(s) and/or dynamic DCI based L1 signaling(s)—e.g., based on or according to a corresponding UE's capability or capability signaling.

The described or specified design examples herein, procedures and/or embodiments can be extended or applied to a single list of higher layer configured PLOs that is configured to have or having one or more (different) parts or sub-lists or groups of PLOs. For example, the described or specified design examples herein, procedures and/or embodiments related/specific to multiple lists of PLOs can be extended or applied to a single list of higher layer configured PLOs that is configured to have or having multiple parts or sub-lists or groups of PLOs by replacing the (different) lists of PLOs with the (different) parts/sub-lists/groups of PLOs in the single list. Or equivalently, different lists of PLOs as defined/specified herein in the present disclosure could correspond to different parts or components of a same pool of PLOs provided by a single higher layer parameter—e.g., ploPool.

For the described or specified design examples herein, a UE could be first configured or provided by the network, e.g., via higher layer RRC signaling(s)/parameter(s) and/or MAC CE command(s) and/or dynamic DCI based L1 signaling(s)—e.g., based on or according to a corresponding UE's capability or capability signaling, a list/set/pool of PLOs (e.g., a first list of PLOs as specified/defined herein in the present disclosure) according to those specified herein in the present disclosure. When/if the UE reports their capability (e.g., via UE's capability signaling) of supporting more than one lists/sets/pools of PLOs, the UE could be further configured or provided by the network, e.g., via higher layer RRC signaling(s)/parameter(s) and/or MAC CE command(s) and/or dynamic DCI based L1 signaling(s)—e.g., based on or according to the corresponding UE's capability or capability signaling, additional list(s)/set(s)/pool(s) of PLOs to the first list/set/pool of PLOs (e.g., a second list of PLOs as specified/defined herein in the present disclosure) according to those specified herein in the present disclosure; for this case/setting, the UE could follow the design examples, procedures and/or embodiments specified herein in the present disclosure related/specific to multiple lists/sets/pools of PLOs to determine candidate PLOs for PL estimate(s) for the single-TRP and asymmetric UL-only multi-TRP operation(s). Otherwise, the UE could follow the design examples, procedures and/or embodiments specified herein in the present disclosure related/specific to a single list/set/pool of PLOs to determine candidate PLOs for PL estimate(s) for the single-TRP and asymmetric UL-only multi-TRP operation(s).

FIG. 8 illustrates a diagram of an example TCI state 800 according to embodiments of the present disclosure. For example, TCI state 800 can be utilized by any of the UEs 111-116 of FIG. 1, such as the UE 112. This example is for illustration only and other embodiments can be used without departing from the scope of the present disclosure.

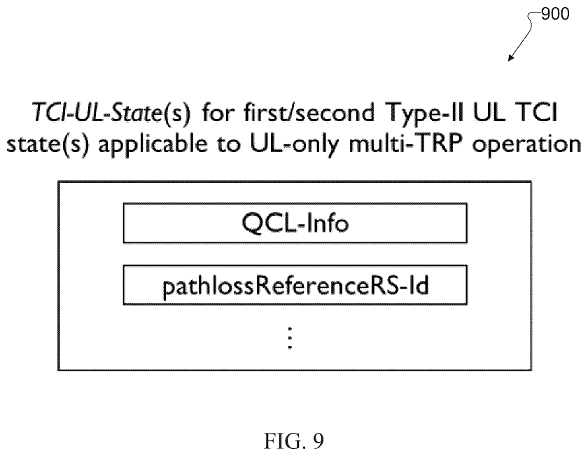

FIG. 9 illustrates a diagram of an example TCI state 900 according to embodiments of the present disclosure. For example, TCI state 900 can be utilized by any of the UEs 111-116 of FIG. 1, such as the UE 113. This example is for illustration only and other embodiments can be used without departing from the scope of the present disclosure.

When/if the single-TRP and UL-only multi-TRP operation(s) is enabled according to those specified herein in the present disclosure, a UE could be configured or provided or indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, a maximum value of PLO—e.g., denoted by PLOₘₐₓ—such that the configured, activated, selected or indicated PLO values are less than or equal to PLOₘₐₓ. Furthermore, the UE could also be configured or provided or indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, a PLO threshold—e.g., denoted by PLO_{TH}—for comparison with a PLO value.

As described herein in the present disclosure, for a single-TRP and UL-only multi-TRP system, a UE could first obtain PL measurement(s) or estimate(s) for the primary network node by (directly) measuring the PL RS(s) transmitted from the primary network node; furthermore, under the NR Rel-17/18 unified TCI framework(s), information related to the PL RS(s) or the PL RS ID(s) is indicated or provided in TCI-State(s) and/or TCI-UL-State(s).

In particular, when/if the single-TRP and UL-only multi-TRP operation(s) is enabled, triggered or initiated according to those specified herein in the present disclosure, a UE could receive from the network (e.g., the network 130) a (unified) TCI state(s) activation MAC CE command, used to map up to Kₜₒₜ, e.g., 8, Type-I TCI states and/or pairs of Type-I TCI states, with each pair comprising of one Type-I TCI state for DL channels/signals and/or one Type-I TCI state for UL channels/signals, and/or sets of Type-II TCI states, wherein each set could be comprised of up to two (e.g., none, one or two) Type-II TCI state(s) for UL channels/signals—e.g., a first Type-II UL TCI state and a second Type-II UL TCI state in a pair, to the codepoints (e.g., each with kₜₒₜ=└log₂Kₜₒₜ┘ bits) of a TCI field in a beam indication DCI (e.g., UL DCI format 00, 01, or 0_2 with or without UL grant, and/or DL DCI format 10, 1_1 or 1_2 with or without DL assignment) for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. Here, the Type-I and Type-II TCI states as specified herein in the present disclosure could be respectively used/applied for the single-TRP and UL-only multi-TRP operations according to those specified herein in the present disclosure. In particular, each of the TCI codepoint(s) activated in/by the (unified) TCI state(s) activation/deactivation MAC CE command as described herein in the present disclosure could correspond to or could comprise or could be mapped to one of:
Case A: a Type-I joint TCI state provided by TCI-State
Case B: a Type-I DL TCI state provided by TCI-State
Case C: a Type-I UL TCI state provided by TCI-UL-State
Case D: a pair of a Type-I DL TCI state provided by TCI-State and a Type-I UL TCI state provided by TCI-UL-State
Case E: a first Type-II UL TCI state provided by TCI-UL-State
Case F: a second Type-II UL TCI state provided by TCI-UL-State
Case G: a pair of a first Type-II UL TCI state provided by TCI-UL-State and a second Type-II UL TCI state provided by TCI-UL-State
Case H: a Type-I joint TCI state (Case A) and a first Type-II UL TCI state (Case E)
Case I: a Type-I joint TCI state (Case A) and a second Type-II UL TCI state (Case F)
Case J: a Type-I joint TCI state (Case A) and a pair of a first Type-II UL TCI state and a second Type-II UL TCI state (Case G)
Case K: a Type-I DL TCI state (Case B) and a first Type-II UL TCI state (Case E)
Case L: a Type-I DL TCI state (Case B) and a second Type-II UL TCI state (Case F)
Case M: a Type-I DL TCI state (Case B) and a pair of a first Type-II UL TCI state and a second Type-II UL TCI state (Case G)
Case N: a Type-I UL TCI state (Case C) and a first Type-II UL TCI state (Case E)
Case O: a Type-I UL TCI state (Case C) and a second Type-II UL TCI state (Case F)
Case P: a Type-I UL TCI state (Case C) and a pair of a first Type-II UL TCI state and a second Type-II UL TCI state (Case G)
Case Q: a pair of a Type-I DL TCI state and a Type-I UL TCI state (Case D) and a first Type-II UL TCI state (Case E)
Case R: a pair of a Type-I DL TCI state and a Type-I UL TCI state (Case D) and a second Type-II UL TCI state (Case F)
Case S: a pair of a Type-I DL TCI state and a Type-I UL TCI state (Case D) and a pair of a first Type-II UL TCI state and a second Type-II UL TCI state (Case G)

When two SRS resource sets—denoted by a first SRS resource set and a second SRS resource set—are configured in srs-ResourceSetToAddModList or srs-ResourceSetToAddModListDCI-0-2 with higher layer parameter usage in SRS-ResourceSet set to ‘codebook’ or ‘noncodebook’, an activated/indicated/applied first (or second) Type-II UL TCI state as defined herein in the present disclosure could be associated/specific to the first SRS resource set, and/or an activated/indicated/applied second (or first) Type-II UL TCI state as defined herein in the present disclosure could be associated/specific to the second SRS resource set. For this setting, the higher layer parameter(s) TCI-State(s) that configures a/the Type-I joint/DL TCI state(s), the higher layer parameter(s) TCI-UL-State(s) that configures a/the Type-I UL TCI state(s), and/or the higher layer parameter(s) TCI-UL-State(s) that configures a/the first Type-II UL TCI state(s) and/or a/the second Type-II UL TCI state(s), according to those described or specified herein in the present disclosure, could provide information related to DL PL RS(s) or DL PL RS ID(s)—as shown in FIG. 8 and FIG. 9, respectively—for PL measurement(s) or estimate(s). The UE (e.g., the UE 116) could then calculate or obtain a downlink pathloss estimate in dB, e.g., for or specific to a TCI state, using DL PL RS ID(s) or index(es) q_{d}, e.g. associated with/specific to the TCI state by indicating q_{d} in the higher layer parameter(s) TCI-State(s) and/or TCI-UL-State(s) that configures the TCI state according to those specified herein in the present disclosure, for an active DL BWP of carrier f of serving cell c as PL_{b,f,c}(qa_{d})=referenceSignalPower—higher layer filtered reference signal received power (RSRP), where referenceSignalPower is provided by higher layers and RSRP is defined for the reference serving cell and the higher layer filter configuration provided by QuantityConfig is defined for the reference serving cell; if the LIE is not configured periodic CSI-RS reception, referenceSignalPower is provided by ss-PBCH-BlockPower; if the UE is configured periodic CSI-RS reception, referenceSignalPower is provided by ss-PBCH-BlockPower or by ss-PBCH-BlockPower and powerControlOffsetSS or by powerControlOffsetSS, wherein powerControlOffsetSS provides an offset of the CSI-RS transmission power relative to the synchronization signal/physical broadcast channel (SS/PBCH) block transmission power; if powerControlOffsetSS is not provided to the UE, the UE expects an offset of 0 dB. In particular, when/if the asymmetric single-TRP and UL-only multi-TRP operation(s) is enabled or triggered or initiated according to those specified herein in the present disclosure, a UE could first determine or calculate a reference downlink pathloss (PL) estimate PL_{b,f,c}^{ref}(q_{d}) in dB, wherein the reference signal (RS) index q_{d} could be determined according to one of:
In one example, the RS index q_{d} could be associated/specific to a/the Type-I joint/DL TCI state(s) as specified herein in the present disclosure: for instance, the RS index q_{d} could correspond to the PL RS index provided in the higher layer parameter(s) TCI-State(s) that configures a/the Type-I joint/DL TCI state(s), and/or the RS corresponding to the RS index q_{d} could be quasi-co-located (QCL'ed), e.g., of ‘typeD’, with the PL RS corresponding to the PL RS index provided in the higher layer parameter(s) TCI-State(s) that configures a/the Type-I joint/DL TCI state(s), and/or the RS index q_{d} could correspond to the RS index, e.g., corresponding to the QCL source RS with ‘typeD’, provided or indicated in the higher layer parameter(s) TCI-State(s) that configures a/the Type-I joint/DL TCI state(s), and/or the RS corresponding to the RS index q_{d} could be quasi-co-located (QCL'ed), e.g., of ‘typeD’, with the RS, e.g., the QCL source RS with ‘typeD’, corresponding to the RS index provided or indicated in the higher layer parameter(s) TCI-State(s) that configures a/the Type-I joint/DL TCI state(s).
In another example, the RS index q_{d} could be associated/specific to a/the Type-I UL TCI state(s) as specified herein in the present disclosure: for instance, the RS index q_{d} could correspond to the PL RS index provided in the higher layer parameter(s) TCI-UL-State(s) that configures a/the Type-I UL TCI state(s), and/or the RS corresponding to the RS index q_{d} could be quasi-co-located (QCL'ed), e.g., of ‘typeD’, with the PL RS corresponding to the PL RS index provided in the higher layer parameter(s) TCI-UL-State(s) that configures a/the Type-I UL TCI state(s), and/or the RS index q_{d} could correspond to the RS index, e.g., corresponding to the QCL source RS with ‘typeD’, provided or indicated in the higher layer parameter(s) TCI-UL-State(s) that configures a/the Type-I UL TCI state(s), and/or the RS corresponding to the RS index q_{d} could be quasi-co-located (QCL'ed), e.g., of ‘typeD’, with the RS, e.g., the QCL source RS with ‘typeD’, corresponding to the RS index provided or indicated in the higher layer parameter(s) TCI-UL-State(s) that configures a/the Type-I UL TCI state(s).
In another example, the RS index q_{d} could be associated/specific to a/the first and/or second Type-II UL TCI state(s) as specified herein in the present disclosure: for instance, the RS index q_{d} could correspond to the PL RS index provided in the higher layer parameter(s) TCI-UL-State(s) that configures a/the first and/or second Type-II UL TCI state(s), and/or the RS corresponding to the RS index q_{d} could be quasi-co-located (QCL'ed), e.g., of ‘typeD’, with the PL RS corresponding to the PL RS index provided in the higher layer parameter(s) TCI-UL-State(s) that configures a/the first and/or second Type-II UL TCI state(s), and/or the RS index q_{d} could correspond to the RS index, e.g., corresponding to the QCL source RS with ‘typeD’, provided or indicated in the higher layer parameter(s) TCI-UL-State(s) that configures a/the first and/or second Type-II UL TCI state(s), and/or the RS corresponding to the RS index q_{d} could be quasi-co-located (QCL'ed), e.g., of ‘typeD’, with the RS, e.g., the QCL source RS with ‘typeD’, corresponding to the RS index provided or indicated in the higher layer parameter(s) TCI-UL-State(s) that configures a/the first and/or second Type-II UL TCI state(s).
In another example, the RS index q_{d} could correspond to a PL RS ID/index provided by pathlossReferenceRS-Id according to: (i) fixed rule(s)/value(s) in system specification(s) and/or per RRC configuration: e.g., the PL RS ID/index could correspond to the first (or last) entry in a set/list/pool of PL RS IDs/indexes higher layer provided/configured/indicated to the UE and/or the lowest (or highest) PL RS ID/index in a set/list/pool of PL RS IDs/indexes higher layer provided/configured/indicated to the UE, (ii) network's configuration(s)/indication(s), e.g., the k-th entry in a set/list/pool of PL RS IDs/indexes higher layer provided/configured/indicated to the UE and/or the k-th lowest (or highest) PL RS ID/index in a set/list/pool of PL RS IDs/indexes higher layer provided/configured/indicated to the UE, wherein the value of k could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, and/or (iii) UE's autonomous determination or selection, which could be further sent to the network via various UL channels/signals.
In another example, the RS index q_{d} could be associated/specific to a TCI state ID/index provided by tci-StateId (and therefore, the RS index q_{d} could correspond to the PL RS ID/index provided in the higher layer parameter TCI-State or TCI-UL-State that provides or configures the TCI state ID/index) according to: (i) fixed rule(s)/value(s) in system specification(s) and/or per RRC configuration: e.g., the PL RS ID/index could be associated/specific to the first (or last) entry in a set/list/pool of TCI state IDs/indexes higher layer provided/configured/indicated to the UE and/or the lowest (or highest) TCI state ID/index in a set/list/pool of TCI state IDs/indexes higher layer provided/configured/indicated to the UE, (ii) network's configuration(s)/indication(s), e.g., the k-th entry in a set/list/pool of TCI state IDs/indexes higher layer provided/configured/indicated to the UE and/or the k-th lowest (or highest) TCI state ID/index in a set/list/pool of TCI state IDs/indexes higher layer provided/configured/indicated to the UE, wherein the value of k could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, and/or (iii) UE's autonomous determination or selection, which could be further sent to the network via various UL channels/signals.

When/if the asymmetric single-TRP and UL-only multi-TRP operation(s) is enabled according to those specified herein in the present disclosure, and/or when/if the UE is indicated by or having one or more of the Type-I joint/DL TCI state(s), Type-I UL TCI state(s), the first Type-II UL TCI state(s) and the second Type-II UL TCI state(s) applicable for one or more DL/UL channels or signals, and/or one or more of the indicated/applied Type-I joint/DL TCI state(s), Type-I UL TCI state(s), the first Type-II UL TCI state(s) and the second Type-II UL TCI state(s) have or provide PL RS index(es), the UE could determine the RS index q_{d} for determining or calculating the reference downlink pathloss (PL) estimate PL_{b,f,c}^{ref}(qa_{d}) as defined herein in the present disclosure according to:
Fixed rule(s)/value(s) in system specification(s):
   For example, the RS index q_{d} could be associated/specific to the indicated/applied Type-I joint/DL TCI state(s); for another example, the RS index q_{d} could be associated/specific to the indicated/applied Type-I UL TCI state(s); for another example, the RS index q_{d} could be associated/specific to the indicated/applied first and/or second Type-II UL TCI state(s).
   For another example, the RS index q_{d} could correspond to a PL RS ID/index provided by pathlossReferenceRS-Id according to fixed rule(s)/value(s) in system specification(s) and/or per RRC configuration: e.g., the PL RS ID/index could correspond to the first (or last) entry in a set/list/pool of PL RS IDs/indexes higher layer provided/configured/indicated to the UE and/or the lowest (or highest) PL RS ID/index in a set/list/pool of PL RS IDs/indexes higher layer provided/configured/indicated to the UE.
   For another example, the RS index q_{d} could be associated/specific to a TCI state ID/index provided by tci-StateId (and therefore, the RS index q_{d} could correspond to the PL RS ID/index provided in the higher layer parameter TCI-State or TCI-UL-State that provides or configures the TCI state ID/index) according to fixed rule(s)/value(s) in system specification(s) and/or per RRC configuration: e.g., the PL RS ID/index could be associated/specific to the first (or last) entry in a set/list/pool of TCI state IDs/indexes higher layer provided/configured/indicated to the UE and/or the lowest (or highest) TCI state ID/index in a set/list/pool of TCI state IDs/indexes higher layer provided/configured/indicated to the UE.
   For another example, the UE could follow a predefined order or ordering of the indicated/applied TCI state(s) to determine the RS index q_{d}. For instance, when/if the higher layer parameter(s) TCI-State(s) that configures the indicated/applied Type-I joint/DL TCI state(s) provides or has a (valid) PL RS ID/index, the UE could determine that the RS index q_{d} could be associated/specific to the indicated/applied Type-I joint/DL TCI state(s); otherwise, i.e., the higher layer parameter(s) TCI-State(s) that configures the indicated/applied Type-I joint/DL TCI state(s) does not provide or have any (valid) PL RS ID(s)/index(es), and/or when/if the higher layer parameter(s) TCI-UL-State(s) that configures the indicated/applied Type-I UL TCI state(s) provides or has a (valid) PL RS ID/index, the UE could determine that the RS index q_{d} could be associated/specific to the indicated/applied Type-I UL TCI state(s); otherwise, i.e., the higher layer parameter(s) TCI-State(s) that configures the indicated/applied Type-I joint/DL TCI state(s) does not provide or have any (valid) PL RS ID(s)/index(es), and/or the higher layer parameter(s) TCI-UL-State(s) that configures the indicated/applied Type-I UL TCI state(s) does not provide or have any (valid) PL RS ID(s)/index(es), and/or when/if the higher layer parameter(s) TCI-UL-State(s) that configures the indicated/applied first and/or second Type-II UL TCI state(s), the UE could determine that the RS index q_{d} could be associated/specific to the indicated/applied first and/or second Type-II UL TCI state(s). Other orders or orderings of the indicated/applied TCI state(s) to determine the RS index q_{d} are also feasible.
   For another example, the UE could determine that the RS index q_{d} for determining or calculating the reference PL estimate is associated/specific to an indicated/applied TCI state—e.g., the indicated/applied Type-I joint/DL TCI state(s) and/or the indicated/applied Type-I UL TCI state(s) and/or the indicated/applied first and/or second Type-II UL TCI state(s) as specified herein in the present disclosure, when/if the higher layer parameter TCI-State(s) and/or TCI-UL-State(s) that configures or provides the indicated/applied TCI state also provides or has or configures information related to path-loss offset(s) or PLO(s) associated/specific to the indicated/applied TCI state.
Network's indication(s) and/or configuration(s), e.g., via higher layer RRC signaling(s)/parameter(s) and/or MAC CE command(s) and/or dynamic DCI based L1 signaling(s).
   For example, the UE could be provided or configured by the network, e.g., in the higher layer parameter(s) TCI-State(s) and/or TCI-UL-State(s) that configures a TCI state—e.g., a Type-I joint/DL TCI state, a Type-I UL TCI state, a first Type-II UL TCI state or a second Type-II UL TCI state as specified/defined herein in the present disclosure, a one-bit indicator. When/if the one-bit indicator, e.g., in the higher layer parameter(s) TCI-State(s) and/or TCI-UL-State(s) that configures an indicated/applied TCI state, is set to ‘1’ (or ‘0’), the UE could determine that the RS index q_{d} for determining or calculating the reference PL estimate is associated/specific to the corresponding indicated/applied TCI state following those specified herein in the present disclosure.
   For another example, the RS index q_{d} could correspond to a PL RS ID/index provided by pathlossReferenceRS-Id according to: network's configuration(s)/indication(s), e.g., the k-th entry in a set/list/pool of PL RS IDs/indexes higher layer provided/configured/indicated to the UE and/or the k-th lowest (or highest) PL RS ID/index in a set/list/pool of PL RS IDs/indexes higher layer provided/configured/indicated to the UE, wherein the value of k could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling.
   For another example, the RS index q_{d} could be associated/specific to a TCI state ID/index provided by tci-StateId (and therefore, the RS index q_{d} could correspond to the PL RS ID/index provided in the higher layer parameter TCI-State or TCI-UL-State that provides or configures the TCI state ID/index) according to: network's configuration(s)/indication(s), e.g., the k-th entry in a set/list/pool of TCI state IDs/indexes higher layer provided/configured/indicated to the UE and/or the k-th lowest (or highest) TCI state ID/index in a set/list/pool of TCI state IDs/indexes higher layer provided/configured/indicated to the UE, wherein the value of k could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling.
   For another example, the UE could be provided or indicated by the network, e.g., in a (unified) TCI state(s) activation/deactivation MAC CE command, one or more indicators (e.g., one or more one-bit indicators, multi-bit indicators, bitmaps, etc.) each associated/specific to a TCI codepoint activated by/in the MAC CE activation command. The one or more indicators could indicate or provide to the UE which one or more of the TCI codepoints activated by/in the MAC CE activation command and/or which one or more of the TCI states of a TCI codepoint activated by/in the MAC CE activation command could be used to determine the RS index q_{d} for determining or calculating the reference PL estimate according to those specified herein in the present disclosure.
   For another example, the UE could be provided or indicated by the network, e.g., in a DCI—e.g., a beam indication DCI of format(s) 0_0, 0_1 and/or 0_2 with or without UL grant and/or format(s) 1_0, 1_1 and/or 1_2 with or without DL assignment, one or more indicators (e.g., one or more one-bit indicators, multi-bit indicators, bitmaps, etc.) to indicate or provide to the UE which one or more of the indicated TCI states could be used to determine the RS index q_{d} for determining or calculating the reference PL estimate according to those specified herein in the present disclosure. In one example, the DCI indicator(s) could be a one-bit indicator; when/if the one-bit indicator is set to ‘1’ (or ‘0’), the RS index q_{d} could be associated/specific to the indicated/applied Type-I join TCI state(s), or the indicated/applied Type-I DL TCI state(s), or the indicated/applied Type-I UL TCI state(s), or the indicated/applied first Type-II UL TCI state(s), or the indicated/applied second Type-II UL TCI state(s). In another example, the DCI indicator(s) could be a one-bit indicator; when/if the one-bit indicator is set to ‘1’ (or ‘0’), the UE could determine that the RS index q_{d} for determining or calculating the reference PL estimate could be associated/specific to the TCI state(s) indicated by/in the DCI. In another example, the DCI indicator(s) could be a multi-bit indicator, e.g., a two-bit indicator; when/if the two-bit indicator is set to ‘00’ (or ‘01’ or ‘10’ or ‘11’), the UE could determine that the RS index q_{d} for determining or calculating the reference PL estimate could be associated/specific to the indicated/applied Type-I joint/DL TCI state(s), when/if the two-bit indicator is set to ‘01’ (or ‘00’ or ‘10’ or ‘11’), the UE could determine that the RS index q_{d} for determining or calculating the reference PL estimate could be associated/specific to the indicated/applied Type-I UL TCI state(s), when/if the two-bit indicator is set to ‘10’ (or ‘00’ or ‘01’ or ‘11’), the UE could determine that the RS index q_{d} for determining or calculating the reference PL estimate could be associated/specific to the indicated/applied first Type-II UL TCI state(s), and/or when/if the two-bit indicator is set to ‘11’ (or ‘00’ or ‘01’ or ‘10’), the UE could determine that the RS index q_{d} for determining or calculating the reference PL estimate could be associated/specific to the indicated/applied second Type-II UL TCI state(s). In another example, the DCI indicator(s) could be a bitmap, e.g., a bitmap of length four; when/if the first entry/bit position of the bitmap is set to ‘1’—i.e., [1 0 0 0], the UE could determine that the RS index q_{d} for determining or calculating the reference PL estimate could be associated/specific to the indicated/applied Type-I joint/DL TCI state(s), when/if the second entry/bit position of the bitmap is set to ‘1’—i.e., [0 1 0 0], the UE could determine that the RS index q_{d} for determining or calculating the reference PL estimate could be associated/specific to the indicated/applied Type-I UL TCI state(s), when/if the third entry/bit position of the bitmap is set to ‘1’—i.e., [0 0 1 0], the UE could determine that the RS index q_{d} for determining or calculating the reference PL estimate could be associated/specific to the indicated/applied first Type-II UL TCI state(s), and/or when/if the fourth entry/bit position of the bitmap is set to ‘1’—i.e., [0 0 0 1], the UE could determine that the RS index q_{d} for determining or calculating the reference PL estimate could be associated/specific to the indicated/applied second Type-II UL TCI state(s). For this case/design example, the DCI indicator(s) could be new or dedicated DCI indicator field(s) in the corresponding DCI format(s); optionally, the DCI indicator(s) could correspond to one or more bits/codepoints of one or more existing DCI fields in the corresponding DCI format(s) by/via repurposing. The UE could be provided or configured by the network (e.g., the network 130), e.g., via higher layer RRC signaling(s)/parameter(s) and/or MAC CE command(s) and/or dynamic DCI based L1 signaling(s), whether or not the DCI indicator(s) as specified/described herein in the present disclosure is present (or absent) in the corresponding DCI format(s).

As described/specified herein in the present disclosure, when/if the single-TRP and UL-only multi-TRP operation(s) is enabled, triggered or initiated according to those specified herein in the present disclosure, and/or when/if the UE is higher layer configured with a list of joint/DL TCI states provided by dl-OrJointTCI-StateList and/or a list of UL TCI states provided by ul-TCI-StateList for the same CC/BWP/serving cell/band, the UE could determine or calculate one or more DL PL estimates (e.g., by measuring the corresponding DL PL RS(s) and/or via the corresponding DL PL RS measurements) according to those specified herein in the present disclosure, wherein one or more of the determined or calculated DL PL estimates could correspond to the reference PL estimate(s) according to those specified herein in the present disclosure. For uplink channel(s) including PUCCH(s) and/or PUSCH(s) and/or uplink signal(s) including SRS(s) associated/specific to an indicated/applied Type-II UL TCI state, e.g., an indicated/applied first Type-II UL TCI state or an indicated/applied second Type-II UL TCI state defined/specified herein in the present disclosure, the UE could determine uplink power control parameter(s) for the uplink channel(s) and/or signal(s) based on or according to PL estimate(s) associated/specific to the indicated/applied Type-II UL TCI state (e.g., the indicated/applied first Type-II UL TCI state or the indicated/applied second Type-II UL TCI state defined/specified herein in the present disclosure):
In one example, the PL estimate(s) associated/specific to the indicated/applied Type-II UL TCI state could correspond to at least a reference PL estimate determined according to those specified herein in the present disclosure.
In another example, the PL estimate(s) associated/specific to the indicated/applied Type-II UL TCI state could correspond to at least a reference PL estimate associated/specific to the indicated/applied Type-I joint/DL/UL TCI state(s) determined according to those specified herein in the present disclosure. For this case/design example, the higher layer parameter(s) TCI-UL-State that configures the indicated/applied Type-II UL TCI state may not provide, contain, include or comprise any PL RS ID(s)/index(es).
   For example, the RS index q_{d} for calculating or determining the reference PL estimate could be associated/specific to the indicated/applied Type-I joint/DL TCI state(s); for another example, the RS index q_{d} for calculating or determining the reference PL estimate could be associated/specific to the indicated/applied Type-I UL TCI state(s).
   For another example, the UE could follow a predefined order or ordering of the indicated/applied TCI state(s) to determine the RS index q_{d} for calculating or determining the reference PL estimate. For instance, when/if the higher layer parameter(s) TCI-State(s) that configures the indicated/applied Type-I joint/DL TCI state(s) provides or has a (valid) PL RS ID/index, the UE could determine that the RS index q_{d} for calculating or determining the reference PL estimate could be associated/specific to the indicated/applied Type-I joint/DL TCI state(s); otherwise, i.e., the higher layer parameter(s) TCI-State(s) that configures the indicated/applied Type-I joint/DL TCI state(s) does not provide or have any (valid) PL RS ID(s)/index(es), and/or when/if the higher layer parameter(s) TCI-UL-State(s) that configures the indicated/applied Type-I UL TCI state(s) provides or has a (valid) PL RS ID/index, the UE could determine that the RS index q_{d} for calculating or determining the reference PL estimate could be associated/specific to the indicated/applied Type-I UL TCI state(s). Other orders or orderings of the indicated/applied TCI state(s) to determine the RS index q_{d} for calculating or determining the reference PL estimate are also feasible.
   For another example, the UE could determine that the RS index q_{d} for determining or calculating the reference PL estimate is associated/specific to an indicated/applied TCI state—e.g., the indicated/applied Type-I joint/DL TCI state(s) and/or the indicated/applied Type-I UL TCI state(s) as specified herein in the present disclosure, when/if the higher layer parameter TCI-State(s) and/or TCI-UL-State(s) that configures or provides the indicated/applied TCI state also provides or has or configures information related to path-loss offset(s) or PLO(s) associated/specific to the indicated/applied TCI state.
   For another example, the UE could be provided or configured by the network, e.g., in the higher layer parameter(s) TCI-State(s) and/or TCI-UL-State(s) that configures a TCI state—e.g., a Type-I joint/DL TCI state or a Type-I UL TCI state as specified/defined herein in the present disclosure, a one-bit indicator. When/if the one-bit indicator, e.g., in the higher layer parameter(s) TCI-State(s) and/or TCI-UL-State(s) that configures an indicated/applied Type-I joint/DL/UL TCI state, is set to ‘1’ (or ‘0’), the UE could determine that the RS index q_{d} for determining or calculating the reference PL estimate is associated/specific to the corresponding indicated/applied Type-I joint/DL/UL TCI state following those specified herein in the present disclosure.
   For another example, the UE could be provided or indicated by the network, e.g., in a (unified) TCI state(s) activation/deactivation MAC CE command, one or more indicators (e.g., one or more one-bit indicators, multi-bit indicators, bitmaps, etc.) each associated/specific to a TCI codepoint activated by/in the MAC CE activation command. The one or more indicators could indicate or provide to the UE which one or more of the TCI codepoints activated by/in the MAC CE activation command and/or which one or more of the TCI states of a TCI codepoint activated by/in the MAC CE activation command could be used to determine the RS index q_{d} for determining or calculating the reference PL estimate according to those specified herein in the present disclosure.
   For another example, the UE could be provided or indicated by the network, e.g., in a DCI—e.g., a beam indication DCI of format(s) 0_0, 0_1 and/or 0_2 with or without UL grant and/or format(s) 1_0, 1_1 and/or 1_2 with or without DL assignment, one or more indicators (e.g., one or more one-bit indicators, multi-bit indicators, bitmaps, etc.) to indicate or provide to the UE which one or more of the indicated Type-I joint/DL/UL TCI states could be used to determine the RS index q_{d} for determining or calculating the reference PL estimate according to those specified herein in the present disclosure. In one example, the DCI indicator(s) could be a one-bit indicator; when/if the one-bit indicator is set to ‘1’ (or ‘0’), the RS index q_{d} for determining or calculating the reference PL estimate could be associated/specific to the indicated/applied Type-I join TCI state(s), or the indicated/applied Type-I DL TCI state(s), or the indicated/applied Type-I UL TCI state(s). In another example, the DCI indicator(s) could be a one-bit indicator; when/if the one-bit indicator is set to ‘1’ (or ‘0’), the UE could determine that the RS index q_{d} for determining or calculating the reference PL estimate could be associated/specific to the Type-I joint/DL/UL TCI state(s) indicated by/in the DCI. In another example, the DCI indicator(s) could be a multi-bit indicator, e.g., a two-bit indicator; when/if the two-bit indicator is set to ‘00’ (or ‘01’ or ‘10’ or ‘11’), the UE (e.g., the UE 116) could determine that the RS index q_{d} for determining or calculating the reference PL estimate could be associated/specific to the indicated/applied Type-I joint TCI state(s), when/if the two-bit indicator is set to ‘01’ (or ‘00’ or ‘10’ or ‘11’), the UE could determine that the RS index q_{d} for determining or calculating the reference PL estimate could be associated/specific to the indicated/applied Type-I DL TCI state(s), and/or when/if the two-bit indicator is set to ‘10’ or ‘11’ (or ‘00’ or ‘01’), the UE could determine that the RS index q_{d} for determining or calculating the reference PL estimate could be associated/specific to the indicated/applied Type-I UL TCI state(s). In another example, the DCI indicator(s) could be a bitmap, e.g., a bitmap of length three; when/if the first entry/bit position of the bitmap is set to ‘1’—i.e., [1 0 0], the UE could determine that the RS index q_{d} for determining or calculating the reference PL estimate could be associated/specific to the indicated/applied Type-I joint TCI state(s), when/if the second entry/bit position of the bitmap is set to ‘1’—i.e., [0 1 0], the UE could determine that the RS index q_{d} for determining or calculating the reference PL estimate could be associated/specific to the indicated/applied Type-I DL TCI state(s), and/or when/if the third entry/bit position of the bitmap is set to ‘1’—i.e., [0 0 1], the UE could determine that the RS index q_{d} for determining or calculating the reference PL estimate could be associated/specific to the indicated/applied Type-I UL TCI state(s). For this case/design example, the DCI indicator(s) could be new or dedicated DCI indicator field(s) in the corresponding DCI format(s); optionally, the DCI indicator(s) could correspond to one or more bits/codepoints of one or more existing DCI fields in the corresponding DCI format(s) by/via repurposing. The UE could be provided or configured by the network, e.g., via higher layer RRC signaling(s)/parameter(s) and/or MAC CE command(s) and/or dynamic DCI based L1 signaling(s), whether or not the DCI indicator(s) as specified/described herein in the present disclosure is present (or absent) in the corresponding DCI format(s).
In another example, the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, association(s)/mapping(s) between one or more reference PL estimates determined according to those specified herein in the present disclosure and one or more Type-II UL TCI states. For example, higher layer parameter(s) TCI-UL-State(s) could comprise, provide, configure, include or contain information related/specific to reference PL estimate(s), wherein the information could include PL RS ID(s)/index(es), TCI state ID(s)/index(es), PL estimate(s), index(es) of reference PL estimate(s) among one or more (reference) PL estimates, other entity IDs including PCI(s), PCI index(es), CORESET pool index(es) and/or etc.; for this design example, when/if the higher layer parameter(s) TCI-UL-State(s) that configures the indicated/applied Type-II UL TCI state has the information related/specific to reference PL estimate(s) as specified/described herein in the present disclosure, the UE could determine the PL estimate(s) associated/specific to the indicated/applied Type-II UL TCI state as the reference PL estimate(s). For another example, the UE could be first higher layer configured with one-to-one association(s)/mapping(s) between one or more UL TCI states (e.g., in form of their TCI state IDs/indexes, higher layer parameters TCI-UL-States, etc.) and one or more reference PL estimates determined according to those specified herein in the present disclosure; for this design example, when/if the indicated/applied Type-II UL TCI state is associated to/with a reference PL estimate according to or based on the one-to-one association(s)/mapping(s), the UE could determine the PL estimate associated/specific to the indicated/applied Type-II UL TCI state as the reference PL estimate. For this case, the higher layer parameter(s) TCI-UL-State that configures the indicated/applied Type-II UL TCI state may not provide, contain, include or comprise any PL RS ID(s)/index(es).
In another example, the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, association(s)/mapping(s) between one or more PL RS IDs/indexes—e.g., each provided by pathlossReferenceRS-Id—and one or more Type-II UL TCI states. For example, higher layer parameter(s) TCI-UL-State(s) could comprise, provide, configure, include or contain information related/specific to the PL RS ID(s)/index(es), wherein the information could include exact value(s) of PL RS ID(s)/index(es), index(es) of the PL RS ID(s)/index(es) among one or more PL RS IDs/indexes, other entity IDs including PCI(s), PCI index(es), CORESET pool index(es) and/or etc.; for this design example, when/if the higher layer parameter(s) TCI-UL-State(s) that configures the indicated/applied Type-II UL TCI state has the information related/specific to the PL RS ID(s)/indexes as specified/described herein in the present disclosure, the UE could determine the PL estimate(s) associated/specific to the indicated/applied Type-II UL TCI state according to the PL RS index(es)/ID(s)—and therefore, the measurement(s) of the corresponding PL RS(s) and/or on the corresponding PL RS resource(s). For another example, the UE could be first higher layer configured with one-to-one association(s)/mapping(s) between one or more UL TCI states (e.g., in form of their TCI state IDs/indexes, higher layer parameters TCI-UL-States, etc.) and one or more PL RS IDs/indexes; for this design example, when/if the indicated/applied Type-II UL TCI state is associated to/with a PL RS ID/index according to or based on the one-to-one association(s)/mapping(s), the UE could determine the PL estimate associated/specific to the indicated/applied Type-II UL TCI state according to the PL RS ID/index—and therefore, the measurement(s) of the corresponding PL RS and/or on the corresponding PL RS resource(s).
In another example, the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, association(s)/mapping(s) between one or more TCI state IDs/indexes—each provided by tci-StateId—and one or more Type-II UL TCI states. For example, higher layer parameter(s) TCI-UL-State(s) could comprise, provide, configure, include or contain information related/specific to the TCI state ID(s)/index(es), wherein the information could include exact value(s) of TCI state ID(s)/index(es), index(es) of the TCI state ID(s)/index(es) among one or more TCI state IDs/indexes, other entity IDs including PCI(s), PCI index(es), CORESET pool index(es) and/or etc.; for this design example, when/if the higher layer parameter(s) TCI-UL-State(s) that configures the indicated/applied Type-II UL TCI state has the information related/specific to the TCI state ID(s)/indexes as specified/described herein in the present disclosure, the UE could determine the PL estimate(s) associated/specific to the indicated/applied Type-II UL TCI state according to the PL RS index(es)/ID(s)—and therefore, the measurement(s) of the corresponding PL RS(s) and/or on the corresponding PL RS resource(s)—provided or configured in the higher layer parameter(s) TCI-State(s) and/or TCI-UL-State(s) that configures or provides the TCI state ID(s)/index(es). For another example, the UE could be first higher layer configured with one-to-one association(s)/mapping(s) between one or more UL TCI states (e.g., in form of their TCI state IDs/indexes, higher layer parameters TCI-UL-States, etc.) and one or more TCI state IDs/indexes; for this design example, when/if the indicated/applied Type-II UL TCI state is associated to/with a TCI state ID/index according to or based on the one-to-one association(s)/mapping(s), the UE could determine the PL estimate associated/specific to the indicated/applied Type-II UL TCI state according to the PL RS ID/index—and therefore, the measurement(s) of the corresponding PL RS and/or on the corresponding PL RS resource(s)—provided or configured in the higher layer parameter(s) TCI-State(s) and/or TCI-UL-State(s) that configures or provides the TCI state ID(s)/index(es). For this case, the higher layer parameter(s) TCI-UL-State that configures the indicated/applied Type-II UL TCI state may not provide, contain, include or comprise any PL RS ID(s)/index(es).
In another example, the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, association(s)/mapping(s) between one or more Type-I joint/DL/UL TCI states and one or more Type-II UL TCI states. For example, higher layer parameter(s) TCI-UL-State(s) could comprise, provide, configure, include or contain information related/specific to Type-I joint/DL/UL TCI state(s), e.g., in form of their TCI state ID(s)/index(es); for this design example, when/if the higher layer parameter(s) TCI-UL-State(s) that configures the indicated/applied Type-II UL TCI state has the information related/specific to a Type-I joint/DL/UL TCI state, e.g., in form of the corresponding TCI state ID/index, as specified/described herein in the present disclosure, the UE could determine the PL estimate(s) associated/specific to the indicated/applied Type-II UL TCI state as the PL estimate(s) associated/specific to the Type-I joint/DL/UL TCI state according to those specified herein in the present disclosure. For another example, the UE could be first higher layer configured with one-to-one association(s)/mapping(s) between one or more UL TCI states (e.g., in form of their TCI state IDs/indexes, higher layer parameters TCI-UL-States, etc.) and one or more joint/DL/UL TCI states (e.g., in form of their TCI state IDs/indexes, higher layer parameters TCI-States/TCI-UL-States, etc.); for this design example, when/if the indicated/applied Type-II UL TCI state is associated to/with a Type-I joint/DL/UL TCI state according to or based on the one-to-one association(s)/mapping(s), the UE could determine the PL estimate associated/specific to the indicated/applied Type-II UL TCI state as the PL estimate associated/specific to the Type-I joint/DL/UL TCI state. For this case, the higher layer parameter(s) TCI-UL-State that configures the indicated/applied Type-II UL TCI state may not provide, contain, include or comprise any PL RS ID(s)/index(es).
In another example, the higher layer parameter TCI-UL-State that configures the indicated/applied Type-II UL TCI state could provide, have, contain, include or comprise a PL RS ID/index, e.g., denoted by pathlossReferenceRS-Id. For this case/design example, the UE could determine that the RS index q_{d} for determining or calculating the PL estimate associated/specific to the indicated/applied Type-II UL TCI state is associated/specific to the indicated/applied Type-II UL TCI state according to those specified herein in the present disclosure—e.g., the RS index q_{d} could correspond to the PL RS ID/index provided in the higher layer parameter TCI-UL-State that configures the indicated/applied Type-II UL TCI state. For this case/design example, the higher layer parameter TCI-UL-State that configures the indicated/applied Type-II UL TCI state may not provide, have, contain, include or comprise any information related to path-loss offset(s) or PLO(s) as specified/defined herein in the present disclosure.
In another example, the PL estimate(s) associated/specific to the indicated/applied Type-II UL TCI state—e.g., an indicated/applied first Type-II UL TCI state or an indicated/applied second Type-II UL TCI state as specified or defined herein in the present disclosure—could be determined according to or based on one of:
   For example, the RS index q_{d} for calculating or determining the PL estimate(s) could be associated/specific to the indicated/applied Type-II UL TCI state following those specified herein in the present disclosure, e.g., when/if the higher layer parameter TCI-UL-State that configures the indicated/applied Type-II UL TCI state could provide, have, contain, include or comprise a PL RS ID/index, e.g., denoted by pathlossReferenceRS-Id, and/or information related to path-loss offset(s) or PLO(s) associated/specific to the indicated/applied Type-II UL TCI state.
   For another example, the UE could be provided or configured by the network, e.g., in the higher layer parameter(s) TCI-UL-State(s) that configures the indicated/applied Type-II UL TCI state, an indicator. In one example, the indicator could be a one-bit indicator. For this case, when/if the one-bit indicator, e.g., in the higher layer parameter(s) TCI-UL-State(s) that configures the indicated Type-II UL TCI state, is set to ‘1’ (or ‘0’), the UE could determine that the RS index q_{d} for determining or calculating the PL estimate(s) is associated/specific to an indicated/applied Type-I joint/DL/UL TCI state following those specified herein in the present disclosure; otherwise, i.e., when/if the one-bit indicator, e.g., in the higher layer parameter(s) TCI-UL-State(s) that configures the indicated Type-II UL TCI state, is set to ‘0’ (or ‘1’), the UE could determine that the RS index q_{d} for determining or calculating the PL estimate(s) is associated/specific to the indicated/applied Type-II UL TCI state following those specified herein in the present disclosure. In another example, the indicator could be a multi-bit indicator, e.g., a two-bit indicator. For this case, when/if the two-bit indicator is set to ‘00’ (or ‘01’ or ‘10’ or ‘11’), the UE could determine that the RS index q_{d} for determining or calculating the PL estimate(s) could be associated/specific to an indicated/applied Type-I joint TCI states, when/if the two-bit indicator is set to ‘01’ (or ‘00’ or ‘10’ or ‘11’), the UE could determine that the RS index q_{d} for determining or calculating the PL estimate(s) could be associated/specific to an indicated/applied Type-I DL TCI state(s), when/if the two-bit indicator is set to ‘10’ (or ‘00’ or ‘01’ or ‘11’), the UE could determine that the RS index q_{d} for determining or calculating the PL estimate(s) could be associated/specific to an indicated/applied Type-I UL TCI state(s), and/or when/if the two-bit indicator is set to ‘11’ (or ‘00’ or ‘01’ or ‘10’), the UE could determine that the RS index q_{d} for determining or calculating the PL estimate(s) could be associated/specific to the indicated/applied Type-II UL TCI state. In another example, the indicator could be a bitmap, e.g., a bitmap of length four; when/if the first entry/bit position of the bitmap is set to ‘1’—i.e., [1 0 0 0], the UE could determine that the RS index q_{d} for determining or calculating the PL estimate(s) could be associated/specific to an indicated/applied Type-I joint TCI state, when/if the second entry/bit position of the bitmap is set to ‘1’—i.e., [0 1 0 0], the UE could determine that the RS index q_{d} for determining or calculating the PL estimate(s) could be associated/specific to an indicated/applied Type-I DL TCI state, when/if the third entry/bit position of the bitmap is set to ‘1’—i.e., [0 0 1 0], the UE could determine that the RS index q_{d} for determining or calculating the PL estimate(s) could be associated/specific to an indicated/applied Type-I UL TCI state, and/or when/if the fourth entry/bit position of the bitmap is set to ‘1’—i.e., [0 0 0 1], the UE could determine that the RS index q_{d} for determining or calculating the PL estimate(s) could be associated/specific to the indicated/applied Type-II UL TCI state.
   For another example, the UE could be provided or indicated by the network, e.g., in a (unified) TCI state(s) activation/deactivation MAC CE command, one or more indicators (e.g., one or more one-bit indicators, multi-bit indicators, bitmaps, etc.) each associated/specific to a TCI codepoint activated by/in the MAC CE activation command. The one or more indicators could indicate or provide to the UE which one or more of the TCI codepoints activated by/in the MAC CE activation command and/or which one or more of the TCI states of a TCI codepoint activated by/in the MAC CE activation command could be used to determine the RS index q_{d} for determining or calculating the PL estimate(s) associated/specific to the indicated/applied Type-II UL TCI state according to those specified herein in the present disclosure.
   For another example, the UE could be provided or indicated by the network, e.g., in a DCI—e.g., a beam indication DCI of format(s) 0_0, 0_1 and/or 0_2 with or without UL grant and/or format(s) 1_0, 1_1 and/or 1_2 with or without DL assignment that indicates/provides one or more TCI states including the Type-II UL TCI state, one or more indicators (e.g., one or more one-bit indicators, multi-bit indicators, bitmaps, etc.) to indicate or provide to the UE which one or more of the indicated/applied TCI states could be used to determine the RS index q_{d} for determining or calculating the PL estimate(s). In one example, the DCI indicator(s) could be a one-bit indicator. For this case, when/if the one-bit indicator is set to ‘1’ (or ‘0’), the UE could determine that the RS index q_{d} for determining or calculating the PL estimate(s) is associated/specific to an indicated/applied Type-I joint/DL/UL TCI state following those specified herein in the present disclosure; otherwise, i.e., when/if the one-bit indicator is set to ‘0’ (or ‘1’), the UE could determine that the RS index q_{d} for determining or calculating the PL estimate(s) is associated/specific to the indicated/applied Type-II UL TCI state following those specified herein in the present disclosure. In another example, the DCI indicator(s) could be a multi-bit indicator, e.g., a two-bit indicator. For this case, when/if the two-bit indicator is set to ‘00’ (or ‘01’ or ‘10’ or ‘11’), the UE could determine that the RS index q_{d} for determining or calculating the PL estimate(s) could be associated/specific to an indicated/applied Type-I joint TCI states, when/if the two-bit indicator is set to ‘01’ (or ‘00’ or ‘10’ or ‘11’), the UE could determine that the RS index q_{d} for determining or calculating the PL estimate(s) could be associated/specific to an indicated/applied Type-I DL TCI state(s), when/if the two-bit indicator is set to ‘10’ (or ‘00’ or ‘01’ or ‘11’), the UE could determine that the RS index q_{d} for determining or calculating the PL estimate(s) could be associated/specific to an indicated/applied Type-I UL TCI state(s), and/or when/if the two-bit indicator is set to ‘11’ (or ‘00’ or ‘01’ or ‘10’), the UE could determine that the RS index q_{d} for determining or calculating the PL estimate(s) could be associated/specific to the indicated/applied Type-II UL TCI state. In another example, the DCI indicator(s) could be a bitmap, e.g., a bitmap of length four; when/if the first entry/bit position of the bitmap is set to ‘1’—i.e., [1 0 0 0], the UE could determine that the RS index q_{d} for determining or calculating the PL estimate(s) could be associated/specific to an indicated/applied Type-I joint TCI state, when/if the second entry/bit position of the bitmap is set to ‘1’—i.e., [0 1 0 0], the UE could determine that the RS index q_{d} for determining or calculating the PL estimate(s) could be associated/specific to an indicated/applied Type-I DL TCI state, when/if the third entry/bit position of the bitmap is set to ‘1’—i.e., [0 0 1 0], the UE could determine that the RS index q_{d} for determining or calculating the PL estimate(s) could be associated/specific to an indicated/applied Type-I UL TCI state, and/or when/if the fourth entry/bit position of the bitmap is set to ‘1’—i.e., [0 0 0 1], the UE could determine that the RS index q_{d} for determining or calculating the PL estimate(s) could be associated/specific to the indicated/applied Type-II UL TCI state. For this case/design example, the DCI indicator(s) could be new or dedicated DCI indicator field(s) in the corresponding DCI format(s); optionally, the DCI indicator(s) could correspond to one or more bits/codepoints of one or more existing DCI fields in the corresponding DCI format(s) by/via repurposing. The UE could be provided or configured by the network, e.g., via higher layer RRC signaling(s)/parameter(s) and/or MAC CE command(s) and/or dynamic DCI based L1 signaling(s), whether or not the DCI indicator(s) as specified/described herein in the present disclosure is present (or absent) in the corresponding DCI format(s).
In another example, when/if the asymmetric single-TRP and UL-only multi-TRP operation(s) is enabled according to those specified herein in the present disclosure, the UE could expect or could be expected or could be configured/indicated by the network (e.g., the network 130) (e.g., via higher layer RRC signaling(s)/parameter(s) and/or MAC CE command(s) and/or dynamic DCI based L1 signaling(s)—e.g., based on a corresponding UE's capability or capability signaling) to receive and measure PL RS(s)—e.g., in form of SSB(s) and/or CSI-RS(s)—transmitted from the UL-only multi-TRP(s). For this example, the UE could first determine that the RS index q_{d} for calculating or determining the PL estimate(s) could be associated/specific to the indicated/applied Type-II UL TCI state, e.g., the RS index q_{d} could correspond to the PL RS index(es)/ID(s) provided/indicated in the higher layer parameter(s) TCI-UL-State(s) that configures the indicated/applied Type-II UL TCI state, wherein the PL RS(s) corresponding to the provided/indicated PL RS index(es)/ID(s) could be transmitted from the UL-only multi-TRP(s) as specified herein in the present disclosure.
   In one example, when/if the higher layer parameter(s) TCI-UL-State(s) that configures the indicated/applied Type-II UL TCI state provides, contains, includes or comprises PL RS index(es)/ID(s) and/or information related to PLO(s), the UE could determine that the PL RS(s) corresponding to the PL RS index(es)/ID(s) provided, contained, included or comprised in the higher layer parameter(s) TCI-UL-State(s) is transmitted from the UL-only multi-TRP(s); otherwise, e.g., when/if the higher layer parameter(s) TCI-UL-State(s) that configures the indicated/applied Type-II UL TCI state does not provide, contain, include or comprise information related to PLO(s), the UE could determine that the PL RS(s) corresponding to the PL RS index(es)/ID(s) provided, contained, included or comprised in the higher layer parameter(s) TCI-UL-State(s) is transmitted from the single-TRP.
   In another example, the UE could be indicated, configured or provided by the network, e.g., via higher layer RRC signaling(s)/parameter(s) and/or MAC CE command(s) and/or dynamic DCI based L1 signaling(s)—e.g., based on a corresponding UE's capability or capability signaling, whether the PL RS(s) corresponding to the provided/indicated PL RS index(es)/ID(s) could be transmitted from the UL-only multi-TRP(s) or the single-TRP as specified herein in the present disclosure. For instance, the higher layer parameter(s) TCI-UL-State(s) that configures the indicated/applied Type-II UL TCI state could provide, indicate, contain, include or comprise a one-bit indicator. When/if the one-bit indicator is set to ‘1’ (or ‘0’), the UE could determine that the PL RS(s) corresponding to the PL RS index(es)/ID(s) provided, contained, included or comprised in the higher layer parameter(s) TCI-UL-State(s) is transmitted from the multi-TRP(s), and/or when/if the one-bit indicator is set to ‘0’ (or ‘1’), the UE could determine that the PL RS(s) corresponding to the PL RS index(es)/ID(s) provided, contained, included or comprised in the higher layer parameter(s) TCI-UL-State(s) is transmitted from the single-TRP.

The UE could then obtain the received signal power(s), e.g., RSRP(s), of the PL RS(s) by measuring the corresponding PL RS resource(s). Furthermore, the UE could be provided or configured with SSB transmission power and/or offset of CSI-RS transmission power relative to the SSB transmission power associated/specific to the UL-only multi-TRP operation(s).
In one example, the UE could be provided by ss-PBCH-BlockPower2 as the SSB transmission power associated/specific to the UL-only multi-TRP(s), and/or powerControlOffsetSS2 as the offset of the CSI-RS transmission power relative to the SSB transmission power associated/specific to the UL-only multi-TRP(s).
In another example, the UE could be configured or provided with a one-bit indicator, e.g., in higher layer parameter(s) that configures or provides SSB transmission power (e.g., ss-PBCH-BlockPower) and/or higher layer parameter(s) that configures or provides offset of CSI-RS transmission power relative to the SSB transmission power (e.g., powerControlOffsetSS). For this case/design example, when/if the one-bit indicator is set to ‘1’ (or ‘0’), the corresponding SSB transmission power and/or the CSI-RS transmission power offset relative to the SSB transmission power could be associated/specific to the UL-only multi-TRP(s), and/or when/if the one-bit indicator is set to ‘0’ (or ‘1’), the corresponding SSB transmission power and/or the CSI-RS transmission power offset relative to the SSB transmission power could be associated/specific to the single-TRP.

For the UL-only multi-TRP(s), the UE could determine the PL estimate(s) associated/specific to the indicated/applied Type-II UL TCI state (e.g., the indicated/applied first Type-II UL TCI state or the indicated/applied second Type-II UL TCI state defined/specified herein in the present disclosure) as PL_{b,f,c}(q_{d})=referenceSignalPower (or referenceSignalPower2)—higher layer filtered RSRP, where the RS index q_{d} could correspond to the PL RS index(es)/ID(s) provided/indicated in the higher layer parameter(s) TCI-UL-State(s) that configures the indicated/applied Type-II UL TCI state, referenceSignalPower (or referenceSignalPower2) could be associated/specific to the UL-only multi-TRP(s) and provided by higher layers and RSRP is defined for the reference serving cell and the higher layer filter configuration provided by QuantityConfig is defined for the reference serving cell; if the UE is not configured periodic CSI-RS reception on the UL-only multi-TRP(s), referenceSignalPower could correspond to the SSB transmission power associated/specific to the UL-only multi-TRP(s)—e.g., provided by ss-PBCH-BlockPower2—as specified herein in the present disclosure; if the UE is configured periodic CSI-RS reception on the UL-only multi-TRP(s), referenceSignalPower could correspond to: (i) the SSB transmission power associated/specific to the UL-only multi-TRP(s)—e.g., provided by ss-PBCH-BlockPower2—as specified herein in the present disclosure, (ii) the offset of the CSI-RS transmission power relative to the SSB transmission power associated/specific to the UL-only multi-TRP(s)—e.g., provided by powerControlOffsetSS2—as specified herein in the present disclosure, or (iii) the SSB transmission power associated/specific to the UL-only multi-TRP(s)—e.g., provided by ss-PBCH-BlockPower2—as specified herein in the present disclosure and the offset of the CSI-RS transmission power relative to the SSB transmission power associated/specific to the UL-only multi-TRP(s)—e.g., provided by powerControlOffsetSS2—as specified herein in the present disclosure; if the CSI-RS transmission power offset relative to the SSB transmission power associated/specific to the UL-only multi-TRP(s)—e.g., provided by powerControlOffsetSS2—is not provided to the UE, the UE could expect the offset as 0 dB.

As specified herein in the present disclosure, when/if the single-TRP and UL-only multi-TRP operation(s) is enabled, triggered or initiated according to those specified herein in the present disclosure, and/or when/if the UE (e.g., the UE 116) is higher layer configured with a list of joint/DL TCI states provided by dl-OrJointTCI-StateList and/or a list of UL TCI states provided by ul-TCI-StateList for the same CC/BWP/serving cell/band, the higher layer parameter(s) TCI-State(s) and/or TCI-UL-State(s) that configures or provides a TCI state—e.g., a Type-I joint TCI state, a Type-I DL TCI state, a Type-I UL TCI state, a first Type-II UL TCI state or a second Type-II UL TCI state as specified herein in the present disclosure—could provide, include, contain, comprise or indicate information related to path-loss offset(s) or PLO(s).
In one example, the higher layer parameter(s) TCI-State(s) and/or TCI-UL-State(s) could contain, provide, indicate, include or comprise one or more PLOs each from the list of N≥1 PLOs provided by ploList or from the M≥1 PLOs provided in/by the PLO(s) sub-selection MAC CE command as specified herein in the present disclosure.
In another example, the higher layer parameter(s) TCI-State(s) and/or TCI-UL-State(s) could contain, provide, indicate, include or comprise one or more PLO indexes, wherein each PLO index could point or correspond to an entry of the list of N≥1 PLOs provided by ploList or an entry of the list of M≥1 PLOs provided in/by the PLO(s) sub-selection MAC CE command as specified herein in the present disclosure. For this design example, for the list of N≥1 PLOs provided by ploLis, the PLO indexes could be 0, 1, . . . , N−1 or 1, 2, . . . , N (i.e., the bitwidth of the PLO indexes could be determined as └log₂N┘), and for the list of M≥1 PLOs provided in/by the PLO(s) sub-selection MAC CE command, the PLO indexes could be 0, 1, . . . , M−1 or 1, 2, . . . , M (i.e., the bitwidth of the PLO indexes could be determined as └log₂M┘).
In another example, the list of higher layer configured N≥1 PLOs could have two parts with part 1 having N₁≥0 PLOs and part 2 having N₂≥0 PLOs (N=N₁+N₂). For this design example, the bitwidth of the PLO indexes for the part 1 of the N₁≥0 PLOs could be determined as └log₂N₁┘, while the bitwidth of the PLO indexes for the part 2 of the N₂≥0 PLOs could be determined as └log₂N₂┘—i.e., the PLO indexes for the part 1 of the N₁≥0 PLOs could be 0, 1, . . . , N₁−1 or 1, 2, . . . , N₁, while the PLO indexes for the part 2 of the N₂≥0 PLOs could be 0, 1, . . . , N₂−1 or 1, 2, . . . , N₂—referred to as local bitwidth determination. Optionally, the bitwidth of the PLO indexes for the part 1 of the N₁≥0 PLOs could be determined as └log₂N┘, while the bitwidth of the PLO indexes for the part 2 of the N₂≥0 PLOs could be determined as └log₂N┘—i.e., the PLO indexes for the part 1 of the N₁≥0 PLOs could be determined as 0, 1, . . . , N₁−1 or 1, 2, . . . , N₁, while the PLO indexes for the part 2 of the N₂≥0 PLOs could be determined as N₁, N₁+1, . . . , N₁+N₂−1 or N₁+1, N₁+2, . . . , N₁+N₂—referred to as global bitwidth determination. For this case, the value(s) of N₁ and/or N₂ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals. The UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, whether the local bitwidth determination or the global bitwidth determination as specified herein in the present disclosure is used/applied. As specified herein in the present disclosure, when/if the single-TRP and UL-only multi-TRP operation(s) is enabled, the UE could use/apply the indicated first Type-II UL TCI state and/or the indicated second Type-II UL TCI state to transmit various UL channels/signals for the UL-only multi-TRP operation(s), wherein the first Type-II UL TCI state and/or the second Type-II UL TCI state could be indicated individually or in a pair by a TCI codepoint of a TCI field in a corresponding beam indication DCI according to those specified herein in the present disclosure.
   When/if the higher layer parameter TCI-UL-State that configures the indicated/applied first Type-II UL TCI state also contains, provides, indicates, includes or comprises one or more PLO indexes, the UE could determine or identify that PLO(s) or PLO value(s) corresponding to the one or more PLO indexes could be from the part 1 (and/or part 2) of the N₁≥0 (and/or N₂≥0) PLOs. When the global bitwidth determination is used/applied according to those specified herein in the present disclosure, the UE may not expect that the higher layer parameter TCI-UL-State that configures the indicated/applied first Type-II UL TCI state could contain, provide, indicate, include or comprise PLO index(es) greater than N₁−1 or N₁ (or less than N₁ or N₁+1).
   When/if the higher layer parameter TCI-UL-State that configures the indicated/applied second Type-II UL TCI state also contains, provides, indicates, includes or comprises one or more PLO indexes, the UE could determine or identify that PLO(s) or PLO value(s) corresponding to the one or more PLO indexes could be from the part 2 (or part 1) of the N₂≥0 (or N₁≥0) PLOs. When the global bitwidth determination is used/applied according to those specified herein in the present disclosure, the UE may not expect that the higher layer parameter TCI-UL-State that configures the indicated/applied second Type-II UL TCI state could contain, provide, indicate, include or comprise PLO index(es) less than N₁ or N₁+1 (or greater than N₁−1 or N₁).
   The higher layer parameter TCI-UL-State that configures an indicated/applied first Type-II UL TCI state could contain, provide, indicate, include or comprise one or more PLO indexes, wherein PLO(s) or PLO value(s) corresponding to the one or more PLO indexes could be from both part 1 of the N₁≥0 PLOs and part 2 of the N₂≥0 PLOs, and/or the higher layer parameter TCI-UL-State that configures an indicated/applied second Type-II UL TCI state could contain, provide, indicate, include or comprise one or more PLO indexes, wherein PLO(s) or PLO value(s) corresponding to the one or more PLO indexes could be from both part 1 of the N₁≥0 PLOs and part 2 of the N₂≥0 PLOs, e.g., regardless whether the local bitwidth determination or the global bitwidth determination is used/applied. For this case/setting, when/if the local bitwidth determination is used/applied, the UE could be further indicated or provided or informed or configured by the network, e.g., via higher layer RRC signaling(s)/parameter(s) and/or MAC CE command(s) and/or dynamic DCI based L1 signaling(s)—e.g., based on or according to a corresponding UE's capability or capability signaling, one or more indicators (e.g., provided in the higher layer parameter(s) TCI-UL-State(s) that configures the indicated/applied first/second Type-II UL TCI(s)) to indicate or provide to the UE from which part(s)—i.e., part 1 and/or part 2—in the list of higher layer configured PLOs the PLO(s) or PLO value(s) corresponding to the PLO index(es) configured or provided in the higher layer parameter(s) TCI-UL-State(s) that configures the indicated/applied first/second Type-II UL TCI state is selected.

In addition, the UE could be configured or provided in srs-ResourceSetToAddModList or srs-ResourceSetToAddModListDCI-0-2 with higher layer parameter usage in SRS-ResourceSet set to ‘codebook’ or ‘noncodebook’, two SRS resource sets—denoted by a first SRS resource set and a second SRS resource set. For this case/setting, part 1 of the N₁≥0 PLOs and part 2 of the N₂≥0 PLOs could be respectively associated/specific to the first and second SRS resource sets. Optionally, the UE could be configured or indicated or informed by the network, e.g., via higher layer RRC signaling(s)/parameter(s) and/or MAC CE command(s) and/or dynamic DCI based L1 signaling(s), the association(s)/mapping(s) between the part 1/part 2 of the configured PLOs and the first/second SRS resource set(s).
In another example, as specified herein in the present disclosure, a UE could be configured/provided by the network or the UE could determine or identify a first list of N₁≥0 PLOs and a second list of N₂≥0 PLOs. For this design example, according to those specified herein in the present disclosure, the bitwidth of the PLO indexes for the first list of N₁≥0 PLOs could be determined as └log₂N₁┘, while the bitwidth of the PLO indexes for the second list of N₂≥0 PLOs could be determined as └log₂N₂┘—i.e., the PLO indexes for the first list of N₁≥0 PLOs could be 0, 1, . . . , N₁−1 or 1, 2, . . . , N₁, while the PLO indexes for the second list of N₂≥0 PLOs could be 0, 1, . . . , N₂−1 or 1, 2, . . . , N₂—referred to as local bitwidth determination. Optionally, the bitwidth of the PLO indexes for the first list of N₁≥0 PLOs could be determined as └log₂N┘, while the bitwidth of the PLO indexes for the second list of N₂≥0 PLOs could be determined as └log₂N┘—i.e., the PLO indexes for the first list of N₁≥0 PLOs could be determined as 0, 1, . . . , N₁−1 or 1, 2, . . . , N₁, while the PLO indexes for the second list of N₂≥0 PLOs could be determined as N₁, N₁+1, . . . , N₁+N₂−1 or N₁+1, N₁+2, . . . , N₁+N₂—referred to as global bitwidth determination. For this case, the value(s) of N₁ and/or N₂ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals. The UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, whether the local bitwidth determination or the global bitwidth determination is used/applied. As specified herein in the present disclosure, when/if the single-TRP and UL-only multi-TRP operation(s) is enabled, the UE could use/apply the indicated first Type-II UL TCI state and/or the indicated second Type-II UL TCI state to transmit various UL channels/signals for the UL-only multi-TRP operation(s), wherein the first Type-II UL TCI state and/or the second Type-II UL TCI state could be indicated individually or in a pair by a TCI codepoint of a TCI field in a corresponding beam indication DCI according to those specified herein in the present disclosure.
   When/if the higher layer parameter TCI-UL-State that configures the indicated/applied first Type-II UL TCI state also contains, provides, indicates, includes or comprises one or more PLO indexes, the UE could determine or identify that PLO(s) or PLO value(s) corresponding to the one or more PLO indexes could be from the first list (or the second list) of the N₁≥0 (or N₂≥0) higher layer configured PLOs. When the global bitwidth determination is used/applied according to those specified herein in the present disclosure, the UE may not expect that the higher layer parameter TCI-UL-State that configures the indicated/applied first Type-II UL TCI state could contain, provide, indicate, include or comprise PLO index(es) greater than N₁−1 or N₁ (or less than N₁ or N₁+1).
   When/if the higher layer parameter TCI-UL-State that configures the indicated/applied second Type-II UL TCI state also contains, provides, indicates, includes or comprises one or more PLO indexes, the UE could determine or identify that PLO(s) or PLO value(s) corresponding to the one or more PLO indexes could be from the second list (or the first list) of the N₂≥0 (or N₁≥0) higher layer configured PLOs. When the global bitwidth determination is used/applied according to those specified herein in the present disclosure, the UE may not expect that the higher layer parameter TCI-UL-State that configures the indicated/applied second Type-II UL TCI state could contain, provide, indicate, include or comprise PLO index(es) less than N₁ or N₁+1 (or greater than N₁−1 or N₁).
   The higher layer parameter TCI-UL-State that configures an indicated/applied first Type-II UL TCI state could contain, provide, indicate, include or comprise one or more PLO indexes, wherein PLO(s) or PLO value(s) corresponding to the one or more PLO indexes could be from both the first list of N₁≥0 PLOs and the second list of N₂≥0 PLOs, and/or the higher layer parameter TCI-UL-State that configures an indicated/applied second Type-II UL TCI state could contain, provide, indicate, include or comprise one or more PLO indexes, wherein PLO(s) or PLO value(s) corresponding to the one or more PLO indexes could be from the first list of N₁≥0 PLOs and the second list of N₂≥0 PLOs, e.g., regardless whether the local bitwidth determination or the global bitwidth determination is used/applied. For this case/setting, when/if the local bitwidth determination is used/applied, the UE could be further indicated or provided or informed or configured by the network, e.g., via higher layer RRC signaling(s)/parameter(s) and/or MAC CE command(s) and/or dynamic DCI based L1 signaling(s)—e.g., based on or according to a corresponding UE's capability or capability signaling, one or more indicators (e.g., provided in the higher layer parameter(s) TCI-UL-State(s) that configures the indicated/applied first/second Type-II UL TCI(s)) to indicate or provide to the UE from which list(s) of higher layer configured PLOs—i.e., the first and/or the second list(s) of PLOs as specified/defined herein in the present disclosure—the PLO(s) or PLO value(s) corresponding to the PLO index(es) configured or provided in the higher layer parameter(s) TCI-UL-State(s) that configures the indicated/applied first/second Type-II UL TCI state is selected.
In another example, the list of MAC CE sub-selected M≥1 PLOs (e.g., in form of M≥1 PLO indexes each corresponding to an entry/PLO value in a list of higher layer configured PLOs and/or M≥1 entries/bit positions in a bitmap set to ‘1’s (or ‘0’s) with each entry/bit position in the bitmap corresponding to an entry/PLO value in a list of higher layer configured PLOs, according to those specified herein in the present disclosure) could have two parts with part 1 having M₁≥0 PLOs and part 2 having M₂≥0 PLOs (M=M₁+M₂), wherein part 1 of the M₁≥0 PLOs could be selected, activated, provided, determined from one or more higher layer configured PLOs in a list following those specified herein in the present disclosure (e.g., from part 1 of the N₁ PLOs in a higher layer configured list of PLOs as specified herein in the present disclosure or from the first list of higher layer configured N₁ PLOs as specified herein in the present disclosure), and/or part 2 of the M₂≥0 PLOs could be selected, activated, provided, determined from one or more higher layer configured PLOs in a list following those specified herein in the present disclosure (e.g., from part 2 of the N₂ PLOs in a higher layer configured list of PLOs as specified herein in the present disclosure or from the second list of higher layer configured N₂ PLOs as specified herein in the present disclosure). For this design example, the bitwidth of the PLO indexes for the part 1 of the M₁≥0 PLOs could be determined as └log₂M₁┘, while the bitwidth of the PLO indexes for the part 2 of the M₂≥0 PLOs could be determined as └log₂M₂┘—i.e., the PLO indexes for the part 1 of the M₁≥0 PLOs could be determined as 0, 1, . . . , M₁−1 or 1, 2, . . . , M₁, while the PLO indexes for the part 2 of the M₂≥0 PLOs could be determined as 0, 1, . . . , M₂−1 or 1, 2, . . . , M₂—referred to as local bitwidth determination. Optionally, the bitwidth of the PLO indexes for the part 1 of the M₁≥0 PLOs could be determined as └log₂M┘, while the bitwidth of the PLO indexes for the part 2 of the M₂≥0 PLOs could be determined as └log₂M┘—i.e., the PLO indexes for the part 1 of the M₁≥0 PLOs could be 0, 1, . . . , M₁−1 or 1, 2, . . . , M₁, while the PLO indexes for the part 2 of the M₂≥0 PLOs could be M₁, M₁+1, . . . , M₁+M₂−1 or M₁+1, M₁+2, . . . , M₁+M₂—referred to as global bitwidth determination. For this case, the value(s) of M₁ and/or M₂ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals. The UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, whether the local bitwidth determination or the global bitwidth determination as specified herein in the present disclosure is used/applied. As specified herein in the present disclosure, when/if the single-TRP and UL-only multi-TRP operation(s) is enabled, the UE could use/apply the indicated first Type-II UL TCI state and/or the indicated second Type-II UL TCI state to transmit various UL channels/signals for the UL-only multi-TRP operation(s), wherein the first Type-II UL TCI state and/or the second Type-II UL TCI state could be indicated individually or in a pair by a TCI codepoint of a TCI field in a corresponding beam indication DCI according to those specified herein in the present disclosure.
   When/if the higher layer parameter TCI-UL-State that configures the indicated/applied first Type-II UL TCI state also contains, provides, indicates, includes or comprises one or more PLO indexes, the UE could determine or identify that PLO(s) or PLO value(s) corresponding to the one or more PLO indexes could be from the part 1 (or part 2) of the M₁≥0 (or M₂≥0) PLOs. When the global bitwidth determination is used/applied according to those specified herein in the present disclosure, the UE may not expect that the higher layer parameter TCI-UL-State that configures the indicated/applied first Type-II UL TCI state could contain, provide, indicate, include or comprise PLO index(es) greater than M₁−1 or M₁ (or less than M₁ or M₁+1).
   When/if the higher layer parameter TCI-UL-State that configures the indicated/applied second Type-II UL TCI state also contains, provides, indicates, includes or comprises one or more PLO indexes, the UE could determine or identify that PLO(s) or PLO value(s) corresponding to the one or more PLO indexes could be from the part 2 (or part 1) of the M₂≥0 (or M₁≥0) PLOs. When the global bitwidth determination is used/applied according to those specified herein in the present disclosure, the UE may not expect that the higher layer parameter TCI-UL-State that configures the indicated/applied second Type-II UL TCI state could contain, provide, indicate, include or comprise PLO index(es) less than M₁ or M₁+1 (or greater than M₁−1 or M₁).
   The higher layer parameter TCI-UL-State that configures an indicated/applied first Type-II UL TCI state could contain, provide, indicate, include or comprise one or more PLO indexes, wherein PLO(s) or PLO value(s) corresponding to the one or more PLO indexes could be from both part 1 of the M₁≥0 PLOs and part 2 of the M₂≥0 PLOs provided/indicated/activated in the PLO(s) sub-selection MAC CE command, and/or the higher layer parameter TCI-UL-State that configures an indicated/applied second Type-II UL TCI state could contain, provide, indicate, include or comprise one or more PLO indexes, wherein PLO(s) or PLO value(s) corresponding to the one or more PLO indexes could be from both part 1 of the M₁≥0 PLOs and part 2 of the M₂≥0 PLOs provided/indicated/activated in the PLO(s) sub-selection MAC CE command, e.g., regardless whether the local bitwidth determination or the global bitwidth determination is used/applied. For this case/setting, when/if the local bitwidth determination is used/applied, the UE could be further indicated or provided or informed or configured by the network, e.g., via higher layer RRC signaling(s)/parameter(s) and/or MAC CE command(s) and/or dynamic DCI based L1 signaling(s)—e.g., based on or according to a corresponding UE's capability or capability signaling, one or more indicators (e.g., provided in the higher layer parameter(s) TCI-UL-State(s) that configures the indicated/applied first/second Type-II UL TCI(s)) to indicate or provide to the UE from which part(s)—i.e., part 1 and/or part 2—of the PLOs provided/indicated/activated in the PLO(s) sub-selection MAC CE command the PLO(s) or PLO value(s) corresponding to the PLO index(es) configured or provided in the higher layer parameter(s) TCI-UL-State(s) that configures the indicated/applied first/second Type-II UL TCI state is selected.

In addition, the UE could be configured or provided in srs-ResourceSetToAddModList or srs-ResourceSetToAddModListDCI-0-2 with higher layer parameter usage in SRS-ResourceSet set to ‘codebook’ or ‘noncodebook’, two SRS resource sets—denoted by a first SRS resource set and a second SRS resource set. For this case/setting, part 1 of the M₁≥0 PLOs and part 2 of the M₂≥0 PLOs could be respectively associated/specific to the first and second SRS resource sets. Optionally, the UE could be configured or indicated or informed by the network, e.g., via higher layer RRC signaling(s)/parameter(s) and/or MAC CE command(s) and/or dynamic DCI based L1 signaling(s), the association(s)/mapping(s) between the part 1/part 2 of the MAC CE sub-selected PLOs/PLO indexes and the first/second SRS resource set(s).
In another example, as specified herein in the present disclosure, a UE could receive from the network (e.g., the network 130) a first PLO(s) sub-selection MAC CE command having/providing/indicating/activating M₁≥0 PLOs (e.g., in form of M₁≥0 PLO indexes each corresponding to an entry/PLO value in a list of higher layer configured PLOs and/or M₁≥0 entries/bit positions in a bitmap set to ‘1’s (or ‘0’s) with each entry/bit position in the bitmap corresponding to an entry/PLO value in a list of higher layer configured PLOs, according to those specified herein in the present disclosure) and a second PLO(s) sub-selection MAC CE command having/providing/indicating/activating M₂≥0 PLOs (e.g., in form of M₂≥0 PLO indexes each corresponding to an entry/PLO value in a list of higher layer configured PLOs and/or M₂≥0 entries/bit positions in a bitmap set to ‘1’s (or ‘0’s) with each entry/bit position in the bitmap corresponding to an entry/PLO value in a list of higher layer configured PLOs, according to those specified herein in the present disclosure), wherein the M₁≥0 PLOs in the first PLO(s) sub-selection MAC CE command could be selected, activated, provided, determined from one or more higher layer configured PLOs in a list following those specified herein in the present disclosure (e.g., from part 1 of N₁ PLOs in a higher layer configured list of PLOs as specified herein in the present disclosure or from the first list of higher layer configured N₁ PLOs as specified herein in the present disclosure), and/or the M₂≥0 PLOs in the second PLO(s) sub-selection MAC CE command could be selected, activated, provided, determined from one or more higher layer configured PLOs in a list following those specified herein in the present disclosure (e.g., from part 2 of N₂PLOs in a higher layer configured list of PLOs as specified herein in the present disclosure or from the second list of higher layer configured N₂ PLOs as specified herein in the present disclosure). For this design example, the bitwidth of the PLO indexes for the M₁≥0 PLOs in the first PLO(s) sub-selection MAC CE command could be determined as └log₂M₁┘, while the bitwidth of the PLO indexes for the M₂≥0 PLOs in the second PLO(s) sub-selection MAC CE command could be determined as └log₂M₂┘—i.e., the PLO indexes for the M₁≥0 PLOs in the first PLO(s) sub-selection MAC CE command could be determined as 0, 1, . . . , M₁−1 or 1, 2, . . . , M₁, while the PLO indexes for the M₂≥0 PLOs in the second PLO(s) sub-selection MAC CE command could be determined as 0, 1, . . . , M₂−1 or 1, 2, . . . , M₂—referred to as local bitwidth determination. Optionally, the bitwidth of the PLO indexes for the M₁≥0 PLOs in the first PLO(s) sub-selection MAC CE command could be determined as └log₂M┘, while the bitwidth of the PLO indexes for the M₂≥0 PLOs in the second PLO(s) sub-selection MAC CE command could be determined as └log₂M┘—i.e., the PLO indexes for the M₁≥0 PLOs in the first PLO(s) sub-selection MAC CE command could be determined as 0, 1, . . . , M₁−1 or 1, 2, . . . , M₁, while the PLO indexes for the M₂≥0 PLOs in the second PLO(s) sub-selection MAC CE command could be determined as M₁, M₁+1, . . . , M₁+M₂−1 or M₁+1, M₁+2, . . . , M₁+M₂—referred to as global bitwidth determination. For this case, the value(s) of M₁ and/or M₂ could be determined according to: (i) fixed value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals. The UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, whether the local bitwidth determination or the global bitwidth determination is used/applied. As specified herein in the present disclosure, when/if the single-TRP and UL-only multi-TRP operation(s) is enabled, the UE could use/apply the indicated first Type-II UL TCI state and/or the indicated second Type-II UL TCI state to transmit various UL channels/signals for the UL-only multi-TRP operation(s), wherein the first Type-II UL TCI state and/or the second Type-II UL TCI state could be indicated individually or in a pair by a TCI codepoint of a TCI field in a corresponding beam indication DCI according to those specified herein in the present disclosure.
   When/if the higher layer parameter TCI-UL-State that configures the indicated/applied first Type-II UL TCI state also contains, provides, indicates, includes or comprises one or more PLO indexes, the UE could determine or identify that PLO(s) or PLO value(s) corresponding to the one or more PLO indexes could be from the M₁≥0 (or M₂≥0) PLOs in the first (or second) PLO(s) sub-selection MAC CE command. When the global bitwidth determination is used/applied according to those specified herein in the present disclosure, the UE may not expect that the higher layer parameter TCI-UL-State that configures the indicated/applied first Type-II UL TCI state could contain, provide, indicate, include or comprise PLO index(es) greater than M₁−1 or M₁ (or less than M₁ or M₁+1).
   When/if the higher layer parameter TCI-UL-State that configures the indicated/applied second Type-II UL TCI state also contains, provides, indicates, includes or comprises one or more PLO indexes, the UE could determine or identify that PLO(s) or PLO value(s) corresponding to the one or more PLO indexes could be from the M₂≥0 (or M₁≥0) PLOs in the second (or first) PLO(s) sub-selection MAC CE command. When the global bitwidth determination is used/applied according to those specified herein in the present disclosure, the UE may not expect that the higher layer parameter TCI-UL-State that configures the indicated/applied second Type-II UL TCI state could contain, provide, indicate, include or comprise PLO index(es) less than M₁ or M₁+1 (or greater than M₁−1 or M₁).
   The higher layer parameter TCI-UL-State that configures an indicated/applied first Type-II UL TCI state could contain, provide, indicate, include or comprise one or more PLO indexes, wherein PLO(s) or PLO value(s) corresponding to the one or more PLO indexes could be from the M₁≥0 PLOs and the M₂≥0 PLOs from both the first and second PLO(s) sub-selection MAC CE commands, and/or the higher layer parameter TCI-UL-State that configures an indicated/applied second Type-II UL TCI state could contain, provide, indicate, include or comprise one or more PLO indexes, wherein PLO(s) or PLO value(s) corresponding to the one or more PLO indexes could be from the M₁≥0 PLOs and the M₂≥0 PLOs from both the first and second PLO(s) sub-selection MAC CE commands, e.g., regardless whether the local bitwidth determination or the global bitwidth determination is used/applied. For this case/setting, when/if the local bitwidth determination is used/applied, the UE could be further indicated or provided or informed or configured by the network, e.g., via higher layer RRC signaling(s)/parameter(s) and/or MAC CE command(s) and/or dynamic DCI based L1 signaling(s)—e.g., based on or according to a corresponding UE's capability or capability signaling, one or more indicators (e.g., provided in the higher layer parameter(s) TCI-UL-State(s) that configures the indicated/applied first/second Type-II UL TCI(s)) to indicate or provide to the UE from which PLO(s) sub-selection MAC CE command(s)—i.e., the first and/or the second PLO(s) sub-selection MAC CE command(s) as specified/defined herein in the present disclosure—the PLO(s) or PLO value(s) corresponding to the PLO index(es) configured or provided in the higher layer parameter(s) TCI-UL-State(s) that configures the indicated/applied first/second Type-II UL TCI state is selected.

As specified herein in the present disclosure, a UE (e.g., the UE 116) could first determine or obtain a reference PL estimate of x dB according to those specified herein in the present disclosure. For an indicated/applied first Type-II UL TCI state as specified/defined herein in the present disclosure, the UE could determine or obtain a corresponding first PLO of y₁ dB with respect to or relative to the reference PL estimate (e.g., information related to the first PLO could be provided or indicated in the higher layer parameter TCI-UL-State that configures the indicated/applied first Type-II UL TCI state according to those specified herein in the present disclosure); for this case, the UE could determine a PL estimate specific to the indicated/applied first Type-II UL TCI state as z₁ dB, where z₁=x+y₁. Furthermore, for an indicated/applied second Type-II UL TCI state as specified/defined herein in the present disclosure, the UE could determine or obtain a corresponding second PLO of y₂ dB with respect to or relative to the reference PL estimate (e.g., information related to the second PLO could be provided or indicated in the higher layer parameter TCI-UL-State that configures the indicated/applied second Type-II UL TCI state according to those specified herein in the present disclosure); for this case, the UE could determine a PL estimate specific to the indicated/applied second Type-II UL TCI state as z₂ dB, where z₂=x+y₂. In one example, the UE could be configured/provided/indicated by the network, e.g., via higher layer RRC signaling(s)/parameter(s) and/or MAC CE command(s) and/or dynamic DCI based L1 signaling(s)—e.g., according to a corresponding UE's capability or capability signaling, whether the higher layer parameter(s) TCI-State(s) and/or TCI-UL-State(s) could contain, provide, indicate, include or comprise (exact) PLO value(s) or PLO index(es) following those specified herein in the present disclosure. In another example, the UE could be configured/provided/indicated by the network, e.g., via higher layer RRC signaling(s)/parameter(s) and/or MAC CE command(s) and/or dynamic DCI based L1 signaling(s)—e.g., according to a corresponding UE's capability or capability signaling, whether the list of higher layer configured NPLOs or the list of MAC CE sub-selected MPLOs could have a single part (i.e., the bitwidth of the PLO indexes is determined according to the total number of PLOs in the list(s)) or two parts (i.e., the bitwidth of the PLO indexes is determined according to the total number of PLOs in the respective part).

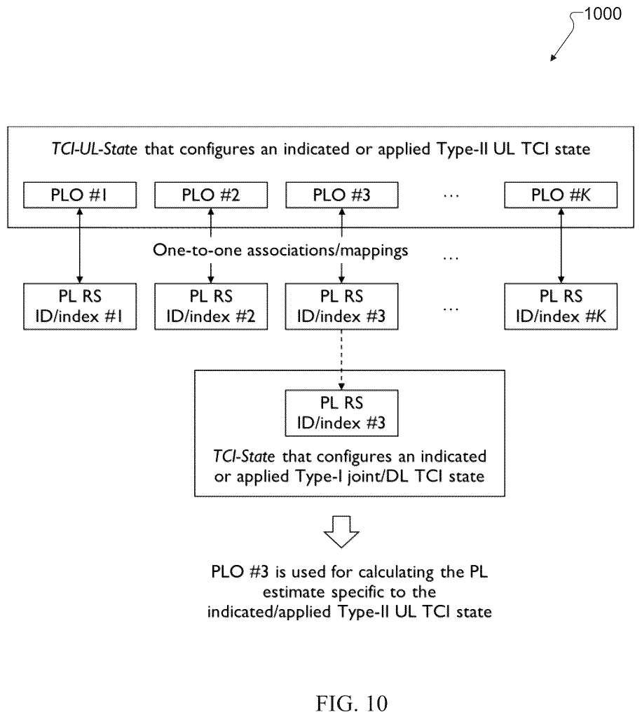

FIG. 10 illustrates a diagram of an example PLO indication 1000 according to embodiments of the present disclosure. For example, PLO indication 1000 can be utilized by the UE 116 of FIG. 3. This example is for illustration only and other embodiments can be used without departing from the scope of the present disclosure.

In one embodiment, according to those specified herein in the present disclosure, when/if the single-TRP and UL-only multi-TRP operation(s) is enabled, triggered or initiated according to those specified herein in the present disclosure, and/or when/if the UE is higher layer configured with a list of joint/DL TCI states provided by dl-OrJointTCI-StateList and/or a list of UL TCI states provided by ul-TCI-StateList for the same CC/BWP/serving cell/band, the higher layer parameter(s) TCI-State(s) and/or TCI-UL-State(s) that configures or provides a TCI state—e.g., a Type-I joint TCI state, a Type-I DL TCI state, a Type-I UL TCI state, a first Type-II UL TCI state or a second Type-II UL TCI state as specified herein in the present disclosure—could provide, include, contain, comprise or indicate a set of PLO values or PLO indexes each associated/specific to a reference PL estimate value, a PL RS ID/index, a TCI state (e.g., in form of their TCI state ID/index) and etc. For instance, for a Type-II UL TCI state—e.g., a first Type-II UL TCI state or a second Type-II UL TCI state as defined herein in the present disclosure, the higher layer parameter TCI-UL-State that configures the Type-II UL TCI state could provide, include, contain, comprise or indicate a set of K≥1 PLO values or PLO indexes; for this case/design example,
In one example, the set of K≥1 PLO values or PLO indexes could be associated with a set of one or more reference PL estimate values determined according to those specified herein in the present disclosure.
   For example, the first PLO value/index or the lowest PLO value/index in the respective set could be associated with the first reference PL estimate or the lowest reference PL estimate in the respective set, the second PLO value/index or the second lowest PLO value/index in the respective set could be associated with the second reference PL estimate or the second lowest reference PL estimate in the respective set, and so on, and the last (i.e., the K-th) PLO value/index or the highest PLO value/index in the respective set could be associated with the last or the highest reference PL estimate in the respective set.
   For another example, the UE could be configured, provided or indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, the association(s)/mapping(s) between the set of K≥1 PLO values or PLO indexes and the set of reference PL estimate(s). For instance, the higher layer parameter TCI-UL-State that configures the Type-II UL TCI state and provides the set of K≥1 PLO values or PLO indexes could also provide, include, contain, comprise or indicate the set of reference PL estimate(s); for this case, each of the PLO value/index in the respective set could be associated/mapped to at least one reference PL estimate in the respective set according to their ordinal positions (e.g., from the first to the last or from the lowest to the highest) in their respective sets.
In another example, the set of K≥1 PLO values or PLO indexes could be associated with a set of one or more PL RS IDs/indexes—e.g., each provided by or associated to a pathlossReferenceRS-Id and/or provided in higher layer parameter(s) TCI-State(s) and/or TCI-UL-State(s) that configures a TCI state, wherein the set of PL RS ID(s)/index(es) could be determined or obtained or identified according to: (i) fixed value(s) in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a UE's capability or capability signaling, and/or (iii) UE's autonomous determination or selection, which could be further sent to the network via various UL channels/signals.
   For example, the first PLO value/index or the lowest PLO value/index in the respective set could be associated with the first PL RS ID/index or the lowest PL RS ID/index in the respective set, the second PLO value/index or the second lowest PLO value/index in the respective set could be associated with the second PL RS ID/index or the second lowest PL RS ID/index in the respective set, and so on, and the last (i.e., the K-th) PLO value/index or the highest PLO value/index in the respective set could be associated with the last or the highest PL RS ID/index in the respective set.
   For another example, the UE could be configured, provided or indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, the association(s)/mapping(s) between the set of K≥1 PLO values or PLO indexes and the set of PL RS ID(s)/index(es). For instance, the higher layer parameter TCI-UL-State that configures the Type-II UL TCI state and provides the set of K≥1 PLO values or PLO indexes could also provide, include, contain, comprise or indicate the set of PL RS ID(s)/index(es); for this case, each of the PLO value/index in the respective set could be associated/mapped to at least one PL RS ID/index in the respective set according to their ordinal positions (e.g., from the first to the last or from the lowest to the highest) in their respective sets.
In another example, the set of K≥1 PLO values or PLO indexes could be associated with a set of one or more TCI state IDs/indexes—e.g., each provided by or associated to a tci-StateId—and therefore, the TCI state(s) along with the corresponding PL RS ID(s)/index(es) associated/specific to the TCI state ID(s)/index(es), wherein the set of TCI state ID(s)/index(es) could be determined or obtained or identified according to: (i) fixed value(s) in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a UE's capability or capability signaling, and/or (iii) UE's autonomous determination or selection, which could be further sent to the network via various UL channels/signals. Furthermore, the higher layer parameter(s) TCI-State(s) and/or TCI-UL-State(s) that configures the TCI state(s) associated/corresponding to the one or more TCI state IDs/indexes or provides the one or more TCI state IDs/indexes could also provide, indicate, contain, include or comprise one or more PL RS IDs/indexes according to those specified herein in the present disclosure.
   For example, the first PLO value/index or the lowest PLO value/index in the respective set could be associated with the first TCI state ID/index or the lowest TCI state ID/index in the respective set, the second PLO value/index or the second lowest PLO value/index in the respective set could be associated with the second TCI state ID/index or the second lowest TCI state ID/index in the respective set, and so on, and the last (i.e., the K-th) PLO value/index or the highest PLO value/index in the respective set could be associated with the last or the highest TCI state ID/index in the respective set.
   For another example, the UE could be configured, provided or indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, the association(s)/mapping(s) between the set of K≥1 PLO values or PLO indexes and the set of TCI state ID(s)/index(es). For instance, the higher layer parameter TCI-UL-State that configures the Type-II UL TCI state and provides the set of K≥1 PLO values or PLO indexes could also provide, include, contain, comprise or indicate the set of TCI state ID(s)/index(es); for this case, each of the PLO value/index in the respective set could be associated/mapped to at least one TCI state ID/index in the respective set according to their ordinal positions (e.g., from the first to the last or from the lowest to the highest) in their respective sets.

As specified herein in the present disclosure, a UE could first determine or obtain (i) a reference PL estimate of x dB, (ii) a PL RS ID/index associated/specific to the reference PL estimate—e.g., the UE could calculate the reference PL estimate according to the PL RS ID/index (and therefore, the measurement(s) of the corresponding PL RS or on the corresponding PL RS resource(s)) following those specified herein in the present disclosure, and/or (iii) a TCI state ID/index associated/specific to the reference PL estimate—e.g., the UE could calculate the reference PL estimate according to a PL RS ID/index (and therefore, the measurement(s) of the corresponding PL RS or on the corresponding PL RS resource(s)), which could be provided in the higher layer parameter(s) TCI-State(s) and/or TCI-UL-State(s) that configures or provides the TCI state ID/index. For an indicated/applied first Type-II UL TCI state as specified/defined herein in the present disclosure, the UE could then determine or identify a first PLO of y₁ dB from or out of a set of K₁≥1 PLO values or PLO indexes provided or configured or indicated in the higher layer parameter TCI-UL-State that configures or provides the indicated/applied first Type-II UL TCI state, according to or based on (a) association(s)/mapping(s) between the set of K₁≥1 PLO values/indexes and the set of reference PL estimate(s)/PL RS ID(s) or index(es)/TCI state ID(s) or index(s) following those specified herein in the present disclosure and (b) the reference PL estimate of x dB, the PL RS ID/index associated/specific to the reference PL estimate of x dB, and/or the TCI state ID/index associated/specific to the reference PL estimate of x dB—i.e., the first PLO of y₁ dB could correspond to the PLO value/index (e.g., in the set of K₂≥1 PLO values/indexes) that is associated with the reference PL estimate and/or the PL RS ID/index and/or the TCI state ID/index according to the association(s)/mapping(s) between the set of K₁≥1 PLO values/indexes and the set of reference PL estimate(s)/PL RS ID(s) or index(es)/TCI state ID(s) or index(s) following those specified herein in the present disclosure; for this case, the UE could determine a PL estimate specific to the indicated/applied first Type-II UL TCI state as z₁ dB, where z₁=x+y₁. Furthermore, for an indicated/applied second Type-II UL TCI state as specified/defined herein in the present disclosure, the UE could then determine or identify a second PLO of y₂ dB from or out of a set of K₂≥1 PLO values or PLO indexes provided or configured or indicated in the higher layer parameter TCI-UL-State that configures or provides the indicated/applied second Type-II UL TCI state, according to or based on (a) association(s)/mapping(s) between the set of K₂≥1 PLO values/indexes and the set of reference PL estimate(s)/PL RS ID(s) or index(es)/TCI state ID(s) or index(s) following those specified herein in the present disclosure and (b) the reference PL estimate of x dB, the PL RS ID/index associated/specific to the reference PL estimate of x dB, and/or the TCI state ID/index associated/specific to the reference PL estimate of x dB—i.e., the second PLO of y₂ dB could correspond to the PLO value/index (e.g., in the set of K₂≥1 PLO values/indexes) that is associated with the reference PL estimate and/or the PL RS ID/index and/or the TCI state ID/index according to the association(s)/mapping(s) between the set of K₂≥1 PLO values/indexes and the set of reference PL estimate(s)/PL RS ID(s) or index(es)/TCI state ID(s) or index(s) following those specified herein in the present disclosure; for this case, the UE could determine a PL estimate specific to the indicated/applied second Type-II UL TCI state as z₂ dB, where z₂=x+y₂ (a conceptual example characterizing the described design procedure herein is provided in FIG. 10). Specifically,
In one example, according to those specified herein in the present disclosure, a UE could first determine or calculate a first reference PL estimate of x₁ dB following those specified herein in the present disclosure—e.g., the first reference PL estimate could be specific to an indicated/applied Type-I joint/DL TCI state such that the RS index q_{d} for calculating the first reference PL estimate could correspond to a PL RS ID/index configured/provided in the higher layer parameter TCI-State that configures the indicated/applied Type-I joint/DL TCI state. Furthermore, for an indicated/applied first Type-II UL TCI state, the UE could determine or identify a first PLO of y₁ dB specific/relative to the first reference PL estimate following those specified herein in the present disclosure, and for an indicated/applied second Type-II UL TCI state, the UE could determine or identify a second PLO of y₂ dB specific/relative to the first reference PL estimate following those specified herein in the present disclosure. The UE could then determine a PL estimate specific to the indicated/applied first Type-II UL TCI state as z₁ dB, where z₁=x₁+y₁, and/or a PL estimate specific to the indicated/applied second Type-II UL TCI state as z₂ dB, where z₂=x₁+y₂. Later in time, the UE could receive from the network an update (or change or switch) for the indicated/applied Type-I joint/DL TCI state—referred to as an updated Type-I joint/DL TCI state. For this case, the UE could determine or calculate a second reference PL estimate of x₂ dB following those specified herein in the present disclosure—e.g., the second reference PL estimate could be specific to the updated Type-I joint/DL TCI state such that the RS index q_{d} for calculating the second reference PL estimate could correspond to a PL RS ID/index configured/provided in the higher layer parameter TCI-State that configures the updated Type-I joint/DL TCI state. Furthermore, for the indicated/applied first Type-II UL TCI state, the UE could determine or identify a third PLO of y₃ dB specific/relative to the second reference PL estimate following those specified herein in the present disclosure, and for the indicated/applied second Type-II UL TCI state, the UE could determine or identify a fourth PLO of y₄ dB specific/relative to the second reference PL estimate following those specified herein in the present disclosure. The UE could then determine an updated PL estimate specific to the indicated/applied first Type-II UL TCI state as z₃ dB, where z₃=x₂+y₃, and/or an updated PL estimate specific to the indicated/applied second Type-II UL TCI state as z₄ dB, where z₄=x₂+y₄.
In another example, according to those specified herein in the present disclosure, a UE could first determine or calculate a reference PL estimate of x dB following those specified herein in the present disclosure—e.g., the reference PL estimate could be specific to an indicated/applied Type-I joint/DL TCI state such that the RS index q_{d} for calculating the reference PL estimate could correspond to a PL RS ID/index configured/provided in the higher layer parameter TCI-State that configures the indicated/applied Type-I joint/DL TCI state. Furthermore, for an indicated/applied first Type-II UL TCI state, the UE could determine or identify a first PLO of y₁ dB specific/relative to the reference PL estimate following those specified herein in the present disclosure, and for an indicated/applied second Type-II UL TCI state, the UE could determine or identify a second PLO of y₂ dB specific/relative to the reference PL estimate following those specified herein in the present disclosure. The UE could then determine a PL estimate specific to the indicated/applied first Type-II UL TCI state as z₁ dB, where z₁=x+y₁, and/or a PL estimate specific to the indicated/applied second Type-II UL TCI state as z₂ dB, where z₂=x+y₂. Later in time, the UE could receive from the network an update (or change or switch) for the indicated/applied first Type-II UL TCI state—referred to as an updated first Type-II UL TCI state, and/or an update (or change or switch) for the indicated/applied second Type-II UL TCI state—referred to as an updated second Type-II UL TCI state. For this case, for the updated first Type-II UL TCI state, the UE could determine or identify a third PLO of y₃ dB specific/relative to the reference PL estimate of x dB following those specified herein in the present disclosure, and for the updated second Type-II UL TCI state, the UE could determine or identify a fourth PLO of y₄ dB specific/relative to the reference PL estimate of x dB following those specified herein in the present disclosure. The UE could then determine an updated PL estimate specific to the updated first Type-II UL TCI state as z₃ dB, where z₃=x+y₃, and/or an updated PL estimate specific to the updated second Type-II UL TCI state as z₄ dB, where z₄=x+y₄.

In one embodiment, according to those specified herein in the present disclosure, when/if the single-TRP and UL-only multi-TRP operation(s) is enabled, triggered or initiated according to those specified herein in the present disclosure, and/or when/if a UE is higher layer configured with a list of joint/DL TCI states provided by dl-OrJointTCI-StateList and/or a list of UL TCI states provided by ul-TCI-StateList for the same CC/BWP/serving cell/band, the UE could be configured or provided or indicated by the network (e.g., the network 130), e.g., via higher layer RRC signaling(s)/parameter(s) and/or MAC CE command(s) and/or dynamic DCI based L1 signaling(s)—e.g., based on a corresponding UE's capability or capability signaling, a set of one or more offset values (e.g., in dBs) each associated/specific to a pair of (reference) PL estimates, and/or a pair of PL RS IDs/indexes, and/or a pair of TCI state IDs/indexes.
In one example, the UE could first determine a set of one or more reference PL estimate values according to those specified herein in the present disclosure. For example, the UE could be configured or provided or indicated by the network, e.g., via higher layer RRC signaling(s)/parameter(s) and/or MAC CE command(s) and/or dynamic DCI based L1 signaling(s)—e.g., based on a corresponding UE's capability or capability signaling, the set of one or more reference PL estimate values. For another example, the UE could calculate or determine the one or more reference PL estimate values in the set according to one or more PL RS IDs/indexes (and therefore, the measurement(s) of the corresponding PL RS(s) or on the corresponding PL RS resource(s)) provided/configured in higher layer parameter(s) TCI-State(s) or TCI-UL-State(s) that configures one or more TCI states, wherein the one or more TCI states could belong to the same list of higher layer configured TCI states (e.g., the same list of joint/DL TCI states provided by dl-OrJointTCI-StateList or the same list of UL TCI states provided by ul-TCI-StateList), and/or could be among the TCI state(s) activated/indicated/provided in/by the same (unified) TCI state(s) activation/deactivation MAC CE command, and/or could be in/of the same TCI codepoint activated/indicated/provided in/by a (unified) TCI state(s) activation/deactivation MAC CE command and/or indicated by a TCI field in a beam indication DCI. For this design example, each offset value in the set could be associated/specific to a pair of two reference PL estimates. For instance, denote a pair of two reference PL estimate values by {x dB, y dB} and an offset value associated/specific to the pair by d dB; for this case, x−y=d or y−x=d depending on network's configuration(s)/indication(s)—e.g., via higher layer RRC signaling(s)/parameter(s) and/or MAC CE command(s) and/or dynamic DCI based L1 signaling(s). Optionally, each/every combination of a pair of two reference PL estimates from the respective set could be associated/specific to an offset value in the set. The association(s)/mapping(s) between the pair(s) of reference PL estimates and the offset value(s) in the set could be determined according to: (i) fixed rule(s) in system specification(s) or per RRC configuration, (ii) network's configuration(s)/indication(s), e.g., via higher layer RRC signaling(s)/parameter(s) and/or MAC CE command(s) and/or dynamic DCI signaling(s)—e.g., based on a corresponding UE's capability or capability signaling, and/or (iii) UE's autonomous determination or selection, which could be further sent to the network via/in various UL channels/signals.
In another example, the UE could first determine a set of one or more PL RS IDs/indexes—e.g., each provided by a pathlossReferenceRS-Id—according to those specified herein in the present disclosure. For example, the UE could be configured or provided or indicated by the network, e.g., via higher layer RRC signaling(s)/parameter(s) and/or MAC CE command(s) and/or dynamic DCI based L1 signaling(s)—e.g., based on a corresponding UE's capability or capability signaling, the set of one or more PL RS IDs/indexes. For another example, the UE could determine the set of one or more PL RS IDs/indexes corresponding to or as the PL RS ID(s)/index(es) provided/configured in higher layer parameter(s) TCI-State(s) or TCI-UL-State(s) that configures one or more TCI states, wherein the one or more TCI states could belong to the same list of higher layer configured TCI states (e.g., the same list of joint/DL TCI states provided by dl-OrJointTCI-StateList or the same list of UL TCI states provided by ul-TCI-StateList), and/or could be among the TCI state(s) activated/indicated/provided in/by the same (unified) TCI state(s) activation/deactivation MAC CE command, and/or could be in/of the same TCI codepoint activated/indicated/provided in/by a (unified) TCI state(s) activation/deactivation MAC CE command and/or indicated by a TCI field in a beam indication DCI. For this design example, each offset value in the set could be associated/specific to a pair of two PL RS IDs/indexes. For instance, for a given pair of two PL RS IDs/indexes, the UE could first determine a pair of two PL estimates (denoted by {x dB, y dB}) respectively calculated according to the two PL RS IDs/indexes (and therefore, the measurement(s) of the corresponding PL RSs or on the corresponding PL RS resources) according to those specified herein in the present disclosure. Furthermore, denote an offset value associated/specific to the pair of two PL RS IDs/indexes by d dB; for this case, x−y=d or y−x=d depending on network's configuration(s)/indication(s)—e.g., via higher layer RRC signaling(s)/parameter(s) and/or MAC CE command(s) and/or dynamic DCI based L1 signaling(s). Optionally, each/every combination of a pair of two PL RS IDs/indexes from the respective set could be associated/specific to an offset value in the set. The association(s)/mapping(s) between the pair(s) of PL RS ID(s)/index(es) and the offset value(s) in the set could be determined according to: (i) fixed rule(s) in system specification(s) or per RRC configuration, (ii) network's configuration(s)/indication(s), e.g., via higher layer RRC signaling(s)/parameter(s) and/or MAC CE command(s) and/or dynamic DCI signaling(s)—e.g., based on a corresponding UE's capability or capability signaling, and/or (iii) UE's autonomous determination or selection, which could be further sent to the network via/in various UL channels/signals.
In another example, the UE could first determine a set of one or more TCI state IDs/indexes—e.g., each provided by a tci-StateId—according to those specified herein in the present disclosure, wherein the higher layer parameter(s) TCI-State(s) and/or TCI-UL-State(s) that configures or provides each of the one or more TCI state IDs/indexes in the set could provide, indicate, include, contain or comprise a PL RS ID/index. For example, the UE could be configured or provided or indicated by the network, e.g., via higher layer RRC signaling(s)/parameter(s) and/or MAC CE command(s) and/or dynamic DCI based L1 signaling(s)—e.g., based on a corresponding UE's capability or capability signaling, the set of one or more TCI state IDs/indexes. For another example, the UE could determine the set of one or more TCI state IDs/indexes from the same list of higher layer configured TCI state IDs/indexes (e.g., the same list of joint/DL TCI states provided by dl-OrJointTCI-StateList or the same list of UL TCI states provided by ul-TCI-StateList), and/or among the TCI state ID(s)/index(es) activated/indicated/provided in/by the same (unified) TCI state(s) activation/deactivation MAC CE command, and/or in/of the same TCI codepoint activated/indicated/provided in/by a (unified) TCI state(s) activation/deactivation MAC CE command and/or indicated by a TCI field in a beam indication DCI. For this design example, each offset value in the set could be associated/specific to a pair of two TCI state IDs/indexes. For instance, for a given pair of two TCI state IDs/indexes, the UE could first determine a pair of two PL estimates (denoted by {x dB, y dB}) respectively calculated according to two PL RS IDs/indexes (and therefore, the measurement(s) of the corresponding PL RSs or on the corresponding PL RS resources) provided or configured in the higher layer parameters TCI-State(s) and/or TCI-UL-State(s) that configures or provides the two TCI state IDs/indexes according to those specified herein in the present disclosure. Furthermore, denote an offset value associated/specific to the pair of two TCI state IDs/indexes by d dB; for this case, x−y=d or y−x=d depending on network's configuration(s)/indication(s)—e.g., via higher layer RRC signaling(s)/parameter(s) and/or MAC CE command(s) and/or dynamic DCI based L1 signaling(s). Optionally, each/every combination of a pair of two TCI state IDs/indexes from the respective set could be associated/specific to an offset value in the set. The association(s)/mapping(s) between the pair(s) of TCI state ID(s)/index(es) and the offset value(s) in the set could be determined according to: (i) fixed rule(s) in system specification(s) or per RRC configuration, (ii) network's configuration(s)/indication(s), e.g., via higher layer RRC signaling(s)/parameter(s) and/or MAC CE command(s) and/or dynamic DCI signaling(s)—e.g., based on a corresponding UE's capability or capability signaling, and/or (iii) UE's autonomous determination or selection, which could be further sent to the network via/in various UL channels/signals.

For this case, the UE (e.g., the UE 116) could determine or calculate PL estimate(s) associated/specific to the indicated/applied first and/or second Type-II UL TCI state(s) according to the set of offset values, and the association(s)/mapping(s) between the set of offset values and a set of reference PL estimates and/or a set of PL RS IDs/indexes and/or a set of TCI state IDs/indexes following those specified herein in the present disclosure. Specifically,
In one example, according to those specified herein in the present disclosure, a UE could first determine or calculate a first reference PL estimate of x₁ dB following those specified herein in the present disclosure—e.g., the first reference PL estimate could be specific to an indicated/applied Type-I joint/DL TCI state such that the RS index q_{d} for calculating the first reference PL estimate could correspond to a PL RS ID/index configured/provided in the higher layer parameter TCI-State that configures the indicated/applied Type-I joint/DL TCI state. Furthermore, for an indicated/applied first Type-II UL TCI state, the UE could determine or identify a first PLO of y₁ dB specific/relative to the first reference PL estimate following those specified herein in the present disclosure, and for an indicated/applied second Type-II UL TCI state, the UE could determine or identify a second PLO of y₂ dB specific/relative to the first reference PL estimate following those specified herein in the present disclosure. The UE could then determine a PL estimate specific to the indicated/applied first Type-II UL TCI state as z₁ dB, where z₁=x₁+y₁, and/or a PL estimate specific to the indicated/applied second Type-II UL TCI state as z₂ dB, where z₂=x₁+y₂. Later in time, the UE could receive from the network an update (or change or switch) for the indicated/applied Type-I joint/DL TCI state—referred to as an updated Type-I joint/DL TCI state. For this case, the UE could determine or calculate a second reference PL estimate of x₂ dB following those specified herein in the present disclosure—e.g., the second reference PL estimate could be specific to the updated Type-I joint/DL TCI state such that the RS index q_{d} for calculating the second reference PL estimate could correspond to a PL RS ID/index configured/provided in the higher layer parameter TCI-State that configures the updated Type-I joint/DL TCI state. Furthermore, the UE could determine or identify an offset value of d dB—from the set of offset values—associated/specific to the pair of reference PL estimates of (x₁ dB, x₂ dB) according to those specified herein (and/or the pair of PL RS IDs/indexes that are respectively configured or provided in the higher layer parameters TCI-States that configure the indicated/applied Type-I joint/DL TCI state and the updated Type-I joint/DL TCI state and respectively result in or lead to the pair of reference PL estimates of (x₁ dB, x₂ dB) according to those specified herein in the present disclosure, and/or the pair of TCI state IDs/indexes that are respectively configured or provided in the higher layer parameters TCI-States that configure the indicated/applied Type-I joint/DL TCI state and the updated Type-I joint/DL TCI state and respectively have the pair of PL RS IDs/indexes resulting in or leading to the pair of reference PL estimates of (x₁ dB, x₂ dB) according to those specified herein in the present disclosure) such that x₁−x₂=d. For this case, for the indicated/applied first Type-II UL TCI state, the UE could determine or identify a third PLO of y₃ dB specific/relative to the second reference PL estimate as (y₁+d) dB or (y₁−d) dB depending on network's configuration(s)/indication(s)—e.g., via higher layer RRC signaling(s)/parameter(s) and/or MAC CE command(s) and/or dynamic DCI based L1 signaling(s), and for the indicated/applied second Type-II UL TCI state, the UE could determine or identify a fourth PLO of y₄ dB specific/relative to the second reference PL estimate as (y₂+d) dB or (y₂−d) dB depending on network's configuration(s)/indication(s)—e.g., via higher layer RRC signaling(s)/parameter(s) and/or MAC CE command(s) and/or dynamic DCI based L1 signaling(s). The UE could then determine an updated PL estimate specific to the indicated/applied first Type-II UL TCI state as z₃ dB, where z₃=x₂+y₃, and/or an updated PL estimate specific to the indicated/applied second Type-II UL TCI state as z₄ dB, where z₄=x₂+y₄.
In another example, according to those specified herein in the present disclosure, a UE could first determine or calculate a reference PL estimate of x dB following those specified herein in the present disclosure—e.g., the reference PL estimate could be specific to an indicated/applied Type-I joint/DL TCI state such that the RS index q_{d} for calculating the reference PL estimate could correspond to a PL RS ID/index configured/provided in the higher layer parameter TCI-State that configures the indicated/applied Type-I joint/DL TCI state. Furthermore, for an indicated/applied first Type-II UL TCI state, the UE could determine or identify a first PLO of y₁ dB specific/relative to the reference PL estimate following those specified herein in the present disclosure, and for an indicated/applied second Type-II UL TCI state, the UE could determine or identify a second PLO of y₂ dB specific/relative to the reference PL estimate following those specified herein in the present disclosure. The UE could then determine a PL estimate specific to the indicated/applied first Type-II UL TCI state as z₁ dB, where z₁=x+y₁, and/or a PL estimate specific to the indicated/applied second Type-II UL TCI state as z₂ dB, where z₂=x+y₂. Later in time, the UE could receive from the network an update (or change or switch) for the indicated/applied first Type-II UL TCI state—referred to as an updated first Type-II UL TCI state, and/or an update (or change or switch) for the indicated/applied second Type-II UL TCI state—referred to as an updated second Type-II UL TCI state. For this case, for the updated first Type-II UL TCI state, the UE could determine or identify an offset value of d₁ dB—from the set of offset values—associated/specific to the pair of TCI state IDs/indexes that are respectively configured or provided in the higher layer parameters TCI-UL-States that configure the indicated/applied first Type-II UL TCI state and the updated first Type-II UL TCI state according to those specified herein in the present disclosure (and/or the pair of PL RS IDs/indexes that are respectively configured or provided in the higher layer parameters TCI-UL-States that configure the indicated/applied first Type-II UL TCI state and the updated first Type-II UL TCI state according to those specified herein in the present disclosure); the UE could determine or identify a third PLO of y₃ dB for the updated first Type-II UL TCI state specific/relative to the reference PL estimate of x dB as (y₁+d₁) dB or (y₁−d₁) dB depending on network's configuration(s)/indication(s)—e.g., via higher layer RRC signaling(s)/parameter(s) and/or MAC CE command(s) and/or dynamic DCI based L1 signaling(s); the UE could then determine an updated PL estimate specific to the updated first Type-II UL TCI state as z₃ dB, where z₃=x+y₃=z₁±d₁. Furthermore, for the updated second Type-II UL TCI state, the UE could determine or identify an offset value of d₂ dB—from the set of offset values—associated/specific to the pair of TCI state IDs/indexes that are respectively configured or provided in the higher layer parameters TCI-UL-States that configure the indicated/applied second Type-II UL TCI state and the updated second Type-II UL TCI state according to those specified herein in the present disclosure (and/or the pair of PL RS IDs/indexes that are respectively configured or provided in the higher layer parameters TCI-UL-States that configure the indicated/applied second Type-II UL TCI state and the updated second Type-II UL TCI state according to those specified herein in the present disclosure); the UE could determine or identify a fourth PLO of y₄ dB for the updated second Type-II UL TCI state specific/relative to the reference PL estimate of x dB as (y₂+d₂) dB or (y₂−d₂) dB depending on network's configuration(s)/indication(s)—e.g., via higher layer RRC signaling(s)/parameter(s) and/or MAC CE command(s) and/or dynamic DCI based L1 signaling(s); the UE could then determine an updated PL estimate specific to the updated second Type-II UL TCI state as z₄ dB, where z₄=x+y₄=z₁±d₂.

In one embodiment, according to those specified herein in the present disclosure, when/if the single-TRP and UL-only multi-TRP operation(s) is enabled, triggered or initiated according to those specified herein in the present disclosure, and/or when/if a UE is higher layer configured with a list of joint/DL TCI states provided by dl-OrJointTCI-StateList and/or a list of UL TCI states provided by ul-TCI-StateList for the same CC/BWP/serving cell/band, the UE could be configured or provided or indicated by the network, e.g., via higher layer RRC signaling(s)/parameter(s) and/or MAC CE command(s) and/or dynamic DCI based L1 signaling(s)—e.g., based on a corresponding UE's capability or capability signaling, one or more offset values (e.g., in dBs) for calculating PL estimate(s). For instance, the UE could receive from the network a TCI state update—e.g., indicated or provided via/by/in a (unified) TCI state(s) activation/deactivation MAC CE command and/or a beam indication DCI (e.g., via/by a TCI codepoint of a TCI field) along with an offset value associated/specific to the TCI state update—e.g., the offset value could be configured or indicated or provided in the higher layer parameter TCI-State or TCI-UL-State that configures the updated TCI state, and/or in the (unified) TCI state(s) activation/deactivation MAC CE command (e.g., via a new filed or a ‘R’ reserved filed) that activates or indicates the updated TCI state, and/or in the beam indication DCI (e.g., via a new DCI field or by repurposing the existing DCI field(s)) that indicates the updated TCI state. Specifically,
In one example, according to those specified herein in the present disclosure, a UE could first determine or calculate a first reference PL estimate of x₁ dB following those specified herein in the present disclosure—e.g., the first reference PL estimate could be specific to an indicated/applied Type-I joint/DL TCI state such that the RS index q_{d} for calculating the first reference PL estimate could correspond to a PL RS ID/index configured/provided in the higher layer parameter TCI-State that configures the indicated/applied Type-I joint/DL TCI state. Furthermore, for an indicated/applied first Type-II UL TCI state, the UE could determine or identify a first PLO of y₁ dB specific/relative to the first reference PL estimate following those specified herein in the present disclosure, and for an indicated/applied second Type-II UL TCI state, the UE could determine or identify a second PLO of y₂ dB specific/relative to the first reference PL estimate following those specified herein in the present disclosure. The UE could then determine a PL estimate specific to the indicated/applied first Type-II UL TCI state as z₁ dB, where z₁=x₁+y₁, and/or a PL estimate specific to the indicated/applied second Type-II UL TCI state as z₂ dB, where z₂=x₁+y₂. Later in time, the UE could receive from the network an update (or change or switch) for the indicated/applied Type-I joint/DL TCI state—referred to as an updated Type-I joint/DL TCI state. For this case, the UE could determine or calculate a second reference PL estimate of x₂ dB following those specified herein in the present disclosure—e.g., the second reference PL estimate could be specific to the updated Type-I joint/DL TCI state such that the RS index q_{d} for calculating the second reference PL estimate could correspond to a PL RS ID/index configured/provided in the higher layer parameter TCI-State that configures the updated Type-I joint/DL TCI state. Furthermore, along with the Type-I joint/DL TCI state update as specified herein in the present disclosure, the UE could also be configured, indicated or provided by the network or could also receive from the network an offset value of d dB according to those specified herein in the present disclosure, wherein the offset value is associated/specific to the Type-I joint/DL TCI state update such that x₁−x₂=d. For this case, for the indicated/applied first Type-II UL TCI state, the UE could determine or identify a third PLO of y₃ dB specific/relative to the second reference PL estimate as (y₁+d) dB or (y₁−d) dB depending on network's configuration(s)/indication(s)—e.g., via higher layer RRC signaling(s)/parameter(s) and/or MAC CE command(s) and/or dynamic DCI based L1 signaling(s), and for the indicated/applied second Type-II UL TCI state, the UE could determine or identify a fourth PLO of y₄ dB specific/relative to the second reference PL estimate as (y₂+d) dB or (y₂−d) dB depending on network's configuration(s)/indication(s)—e.g., via higher layer RRC signaling(s)/parameter(s) and/or MAC CE command(s) and/or dynamic DCI based L1 signaling(s). The UE could then determine an updated PL estimate specific to the indicated/applied first Type-II UL TCI state as z₃ dB, where z₃=x₂+y₃, and/or an updated PL estimate specific to the indicated/applied second Type-II UL TCI state as z₄ dB, where z₄=x₂+y₄.
In another example, according to those specified herein in the present disclosure, a UE could first determine or calculate a reference PL estimate of x dB following those specified herein in the present disclosure—e.g., the reference PL estimate could be specific to an indicated/applied Type-I joint/DL TCI state such that the RS index q_{d} for calculating the reference PL estimate could correspond to a PL RS ID/index configured/provided in the higher layer parameter TCI-State that configures the indicated/applied Type-I joint/DL TCI state. Furthermore, for an indicated/applied first Type-II UL TCI state, the UE could determine or identify a first PLO of y₁ dB specific/relative to the reference PL estimate following those specified herein in the present disclosure, and for an indicated/applied second Type-II UL TCI state, the UE could determine or identify a second PLO of y₂ dB specific/relative to the reference PL estimate following those specified herein in the present disclosure. The UE could then determine a PL estimate specific to the indicated/applied first Type-II UL TCI state as z₁ dB, where z₁=x+y₁, and/or a PL estimate specific to the indicated/applied second Type-II UL TCI state as z₂ dB, where z₂=x+y₂. Later in time, the UE could receive from the network an update (or change or switch) for the indicated/applied first Type-II UL TCI state—referred to as an updated first Type-II UL TCI state, and/or an update (or change or switch) for the indicated/applied second Type-II UL TCI state—referred to as an updated second Type-II UL TCI state. For this case, along with the first Type-II UL TCI state update as specified herein in the present disclosure, the UE could also be configured, indicated or provided by the network or could also receive from the network an offset value of d₁ dB according to those specified herein in the present disclosure, wherein the offset value is associated/specific to the first Type-II UL TCI state update such that the UE could determine or identify a third PLO of y₃ dB for the updated first Type-II UL TCI state specific/relative to the reference PL estimate of x dB as (y₁+d₁) dB or (y₁−d₁) dB depending on network's configuration(s)/indication(s)—e.g., via higher layer RRC signaling(s)/parameter(s) and/or MAC CE command(s) and/or dynamic DCI based L1 signaling(s); the UE could then determine an updated PL estimate specific to the updated first Type-II UL TCI state as z₃ dB, where z₃=x+y₃=z₁±d₁. Furthermore, along with the second Type-II UL TCI state update as specified herein in the present disclosure, the UE could also be configured, indicated or provided by the network or could also receive from the network an offset value of d₂ dB according to those specified herein in the present disclosure, wherein the offset value is associated/specific to the second Type-II UL TCI state update such that the UE could determine or identify a fourth PLO of y₄ dB for the updated second Type-II UL TCI state specific/relative to the reference PL estimate of x dB as (y₂+d₂) dB or (y₂−d₂) dB depending on network's configuration(s)/indication(s)—e.g., via higher layer RRC signaling(s)/parameter(s) and/or MAC CE command(s) and/or dynamic DCI based L1 signaling(s); the UE could then determine an updated PL estimate specific to the updated second Type-II UL TCI state as z₄ dB, where z₄=x+y₄=z₁±d₂.

Throughout the present disclosure, a higher layer parameter TCI-State or TCI-UL-State could provide, indicate, include, contain or comprise a PLO of 0 dB or a PLO index pointing to a 0 dB PLO in the list of PLO values higher layer configured/provided to the UE. For this case, the UE could determine or identify that the higher layer parameter(s), e.g., TCI-State or TCI-UL-State, is to configure Type-I joint/DL/UL TCI state(s). Furthermore, the UE could determine or identify that the PL estimate calculated according to the PL RS ID/index (and therefore, the measurement(s) of the corresponding PL RS or on the corresponding PL RS resource(s)) configured or provided in the higher layer parameter TCI-State or TCI-UL-State could correspond to a reference PL estimate as specified herein in the present disclosure.

For the described/specified design examples/procedures herein throughout the present disclosure, in addition to configuring or providing or including or containing or comprising or indicating information related to the PLO including one or more PLO values in dB, one or more PLO indexes each pointing to an entry of a list/set/pool of PLO values and/or etc. in higher layer parameter(s) TCI-State and/or TCI-UL-State(s) that configures or provides a joint/DL/UL TCI state, the UE could be provided or configured or indicated by the network, e.g., via/in other higher layer RRC signaling(s)/parameter(s) and/or MAC CE command(s) and/or dynamic DCI based L1 signaling(s), the information related to the PLO. Furthermore, the described/specified design examples/procedures herein throughout the present disclosure for determining or calculating PL estimate(s) for the single-TRP and/or UL-only multi-TRP(s) could be applied when the UE is operating at or on frequency range 2. For a UE operating at or on frequency range 1 and/or when/if the single-TRP and UL-only multi-TRP operation(s) is enabled, triggered or initiated according to those specified herein in the present disclosure,
the UE could first determine or calculate a reference PL estimate of x dB following those specified herein in the present disclosure—e.g., the RS index q_{d} for calculating the reference PL estimate could correspond to a PL RS ID/index configured/provided to the UE by the network, e.g., via higher layer RRC signaling(s)/parameter(s)—e.g., in the higher layer parameter TCI-State or TCI-UL-State that configures an indicated/applied Type-I joint/DL TCI state or an indicated/applied Type-I UL TCI state or in the higher layer parameter PathlossReferenceRS associated/specific to the single-TRP operation and/or an indicated/applied Type-I joint/DL/UL TCI state and/or one or more DL channels/signals—and/or MAC CE command(s) and/or dynamic DCI based L1 signaling(s)—e.g., based on a corresponding UE's capability or capability signaling; furthermore, the reference PL estimate could be associated/specific to the single-TRP operation and/or an indicated/applied Type-I joint/DL/UL TCI state and/or one or more DL channels/signals.
the UE could be configured or provided in srs-ResourceSetToAddModList or srs-ResourceSetToAddModListDCI-0-2 with higher layer parameter usage in SRS-ResourceSet set to ‘codebook’ or ‘noncodebook’, two SRS resource sets—denoted by a first SRS resource set and a second SRS resource set; the UE could also be configured/provided/indicated by the network (e.g., the network 130), e.g., via higher layer RRC signaling(s)/parameter(s) and/or MAC CE command(s) and/or dynamic DCI based L1 signaling(s)—e.g., based on a corresponding UE's capability or capability signaling, one or more (e.g., P≥1) PLO values or PLO indexes each pointing/corresponding to an entry in a list/set/pool of RRC configured and/or MAC CE sub-selected PLO values according to those specified herein in the present disclosure, wherein each of the one or more PLO values/indexes could be associated/specific to the multi-TRP operation and/or an indicated/applied Type-II UL TCI state (an indicated/applied first Type-II UL TCI state or an indicated/applied second Type-II UL TCI state) and/or one or more UL channels/signals. For instance, for P=2, the UE could be configured/provided/indicated by the network, e.g., via higher layer RRC signaling(s)/parameter(s) and/or MAC CE command(s) and/or dynamic DCI based L1 signaling(s)—e.g., based on a corresponding UE's capability or capability signaling, a first PLO value of y₁ dB and a second PLO value of y₂ dB or a first and a second PLO indexes each pointing/corresponding to an entry (e.g., PLOs of y₁ and y₂ dBs) in a list/set/pool of RRC configured and/or MAC CE sub-selected PLO values according to those specified herein in the present disclosure. For this case, the first PLO value/index could be associated/specific to the first (or second) SRS resource set, and/or the second PLO value/index could be associated/specific to the second (or first) SRS resource set.

The UE could then determine a first PL estimate specific to the first SRS resource set (and therefore, the corresponding UL channels/signals including PUSCH, PUCCH and/or SRS) as z₁ dB, where z₁=x+y₁, and/or a second PL estimate specific to the second SRS resource set (and therefore, the corresponding UL channels/signals including PUSCH, PUCCH and/or SRS) as z₂ dB, where z₂=x+y₂. In the described/specified design examples herein, the first and second SRS resource sets could be replaced by/with first and second CORESETs associated/configured with coresetPoolIndex values 0 and 1 (if configured/provided in PDCCH-Config for respective CORESETs) and/or associated/configured with coresetGroupIndex values 0 and 1 (if configured/provided in PDCCH-Config for respective CORESETs). In addition, the UE could be indicated or instructed or informed or configured or provided by the network, e.g., e.g., via higher layer RRC signaling(s)/parameter(s) and/or MAC CE command(s) and/or dynamic DCI based L1 signaling(s)—e.g., based on a corresponding UE's capability or capability signaling, (i) whether or not the design examples/procedures for determining or calculating PL estimate(s) for the single-TRP and/or UL-only multi-TRP(s) as described/specified herein in the present disclosure for a UE operating at or on frequency range 2 can be applied for determining or calculating PL estimate(s) for the single-TRP and/or UL-only multi-TRP(s) to a UE operating at or on frequency range 1, and/or (ii) whether or not the design examples/procedures for determining or calculating PL estimate(s) for the single-TRP and/or UL-only multi-TRP(s) as described/specified herein in the present disclosure for a UE operating at or on frequency range 1 can be applied for determining or calculating PL estimate(s) for the single-TRP and/or UL-only multi-TRP(s) to a UE operating at or on frequency range 2. When/if the design examples/procedures for determining or calculating PL estimate(s) for the single-TRP and/or UL-only multi-TRP(s) as described/specified herein in the present disclosure for a UE operating at or on frequency range 2 (denoted by or referred to as method(s) I here) and for a UE operating at or on frequency range 1 (denoted by or referred to as method(s) II here) are both applicable to a UE (e.g., agnostic to or regardless of the operation/operating frequency range(s)), the UE could be indicated or instructed or informed or configured or provided by the network, e.g., e.g., via higher layer RRC signaling(s)/parameter(s) and/or MAC CE command(s) and/or dynamic DCI based L1 signaling(s)—e.g., based on a corresponding UE's capability or capability signaling, whether to use or follow method(s) I and/or method(s) II as specified herein in the present disclosure for determining or calculating PL estimate(s) for the single-TRP and/or UL-only multi-TRP(s) as described/specified herein in the present disclosure.

In one embodiment, when/if the single-TRP and UL-only multi-TRP operation(s) is enabled according to those specified herein in the present disclosure, a UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, one or more lists of PL RS IDs/indexes and one or more lists of PLO values as defined/specified herein in the present disclosure. The UE could determine or identify association(s)/mapping(s) between one or more of the PL RS IDs/indexes in the one or more lists of PL RS IDs/indexes and one or more PLO values in the one or more lists of PLO values according to: (i) fixed rule(s)/value(s) in system specification(s), (ii) network's configuration(s)/indication(s), e.g., via/by higher layer RRC signaling(s) and/or MAC CE command(s) and/or dynamic DCI based L1 signaling(s), e.g., based on a corresponding UE's capability or capability signaling, and/or (iii) UE's autonomous selection or determination, which could be further sent to the network via various UL channels/signals.
In one example, a UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, a list of PL RS IDs/indexes and a list of PLO values as defined/specified herein in the present disclosure. For this case/design example, the PL RS IDs/indexes in the list of PL RS IDs/indexes could be one-to-one mapped/associated to the PLO values in the list of PLO values.
   The association(s)/mapping(s) between the PL RS IDs/indexes in the list of PL RS IDs/indexes and the PLO values in the list of PLO values could be fixed in system specification(s) or per RRC configuration. For example, the first PL RS ID/index or the lowest PL RS ID/index in the respective list could be associated/specific to the first or the lowest PLO value in the respective list, the second PL RS ID/index or the second lowest PL RS ID/index in the respective list could be associated/specific to the second or the second lowest PLO value in the respective list, and so on, and the last PL RS ID/index or the highest PL RS ID/index in the respective list could be associated/specific to the last or the highest PLO value in the respective list. For this design example, when/if a PL RS ID/index is provided in a higher layer parameter TCI-State or TCI-UL-State that configures a TCI state (e.g., TCI-UL-State that configures an indicated/applied first/second Type-II UL TCI state as specified herein in the present disclosure), the UE could identify or determine a PLO value associated/specific to the PL RS ID index following the association/mapping rule(s) described/specified herein in the present disclosure. The UE (e.g., the UE 116) could then determine or calculate a PL estimate based on the PL RS ID/index and the associated PLO value according to those specified herein in the present disclosure, for determining UL power control parameters specific to/for the UL channels/signals including PUCCH, PUSCH and/or SRS that are associated/specific to the TCI state and/or the respective SRS resource set—e.g., the first and/or the second SRS resource set(s) depending on network's configurations/indications (e.g., the TCI state here could correspond to the indicated/applied first/second Type-II UL TCI state, and the respective SRS resource set here could correspond to the associated first/second SRS resource set(s), if configured, following those specified herein in the present disclosure).
   The association(s)/mapping(s) between the PL RS IDs/indexes in the list of PL RS IDs/indexes and the PLO values in the list of PLO values could be configured, indicated, provided and/or informed to the UE via higher layer RRC signaling(s)/parameter(s) and/or MAC CE command(s) and/or dynamic DCI based L1 signaling(s)—e.g., based on a corresponding UE's capability or capability signaling. For example, a higher layer parameter TCI-State or TCI-UL-State that configures a TCI state (e.g., TCI-UL-State that configures an indicated/applied first/second Type-II UL TCI state as specified herein in the present disclosure) that configures or provides a PL RS ID/index could also configure or provide a PLO value/index. The UE could then determine or calculate a PL estimate based on the PL RS ID/index and the PLO value/index—provided/configured in the same higher layer parameter TCI-State or TCI-UL-State—according to those specified herein in the present disclosure, for determining UL power control parameters specific to/for the UL channels/signals including PUCCH, PUSCH and/or SRS that are associated/specific to the TCI state and/or the respective SRS resource set—e.g., the first and/or the second SRS resource set(s) depending on network's configurations/indications (e.g., the TCI state here could correspond to the indicated/applied first/second Type-II UL TCI state, and the respective SRS resource set here could correspond to the associated first/second SRS resource set(s), if configured, following those specified herein in the present disclosure).
   The association(s)/mapping(s) between the PL RS IDs/indexes in the list of PL RS IDs/indexes and the PLO values in the list of PLO values could be configured, indicated, provided and/or informed to the UE via higher layer RRC signaling(s)/parameter(s) and/or MAC CE command(s) and/or dynamic DCI based L1 signaling(s)—e.g., based on a corresponding UE's capability or capability signaling. For example, a higher layer parameter TCI-State or TCI-UL-State that configures a TCI state (e.g., TCI-State that configures an indicated/applied Type-I joint/DL TCI state as specified herein in the present disclosure) that configures or provides a PL RS ID/index could also configure or provide a PLO value/index and an indicator. For instance, when/if the indicator is set to ‘1’ (or ‘0’) or ‘first’ (or ‘second’ or ‘both’), the UE could then determine or calculate a PL estimate based on the PL RS ID/index and the PLO value/index—provided/configured in the same higher layer parameter TCI-State or TCI-UL-State—according to those specified herein in the present disclosure, for determining UL power control parameters specific to/for the UL channels/signals including PUCCH, PUSCH and/or SRS that are associated/specific to indicated/applied first Type-II UL TCI state and/or the first SRS resource set (e.g., the TCI state here could correspond to the indicated/applied first Type-II UL TCI state). Alternatively, when/if the indicator is set to ‘0’ (or ‘1’) or ‘second’ (or ‘first’ or ‘both’), the UE could then determine or calculate a PL estimate based on the PL RS ID/index and the PLO value/index—provided/configured in the same higher layer parameter TCI-State or TCI-UL-State—according to those specified herein in the present disclosure, for determining UL power control parameters specific to/for the UL channels/signals including PUCCH, PUSCH and/or SRS that are associated/specific to the indicated/applied second Type-II UL TCI state and/or the second SRS resource set.
In another example, a PL RS ID/index in a list of higher layer configured PL RS IDs/indexes could be associated/specific to two PLO values in a list of higher layer configured PLOs, e.g., according to: fixed rule(s) in system specification(s) and/or network's configuration(s)/indication(s), e.g., via/by higher layer RRC signaling(s) and/or MAC CE command(s) and/or dynamic DCI based L1 signaling(s), e.g., based on a corresponding UE's capability or capability signaling.
   For fixed association/mapping rule(s), when/if a PL RS ID/index is provided in a higher layer parameter TCI-State or TCI-UL-State that configures a TCI state (e.g., TCI-State that configures an indicated/applied Type-I joint/DL TCI state as specified herein in the present disclosure), the UE could identify or determine a first and a second PLO values associated/specific to the PL RS ID index following the fixed association/mapping rule(s) described/specified herein in the present disclosure. The UE could then determine or calculate a first PL estimate based on the PL RS ID/index and the associated first PLO value according to those specified herein in the present disclosure, for determining UL power control parameters specific to/for the UL channels/signals including PUCCH, PUSCH and/or SRS that are associated/specific to the indicated/applied first Type-II UL TCI state and/or the first SRS resource set, and a second PL estimate based on the PL RS ID/index and the associated second PLO value according to those specified herein in the present disclosure, for determining UL power control parameters specific to/for the UL channels/signals including PUCCH, PUSCH and/or SRS that are associated/specific to the indicated/applied second Type-II UL TCI state and/or the second SRS resource set.
   Optionally, a higher layer parameter TCI-State or TCI-UL-State that configures a TCI state (e.g., TCI-State that configures an indicated/applied Type-I joint/DL TCI state as specified herein in the present disclosure) that configures or provides a PL RS ID/index could also configure or provide a first and a second PLO values/indexes. The UE could then determine or calculate a first PL estimate based on the PL RS ID/index and the first PLO value/index-provided/configured in the same higher layer parameter TCI-State or TCI-UL-State—according to those specified herein in the present disclosure, for determining UL power control parameters specific to/for the UL channels/signals including PUCCH, PUSCH and/or SRS that are associated/specific to the indicated/applied first Type-II UL TCI state and/or the first SRS resource set, and a second PL estimate based on the PL RS ID/index and the second PLO value/index—provided/configured in the same higher layer parameter TCI-State or TCI-UL-State—according to those specified herein in the present disclosure, for determining UL power control parameters specific to/for the UL channels/signals including PUCCH, PUSCH and/or SRS that are associated/specific to the indicated/applied second Type-II UL TCI state and/or the second SRS resource set.

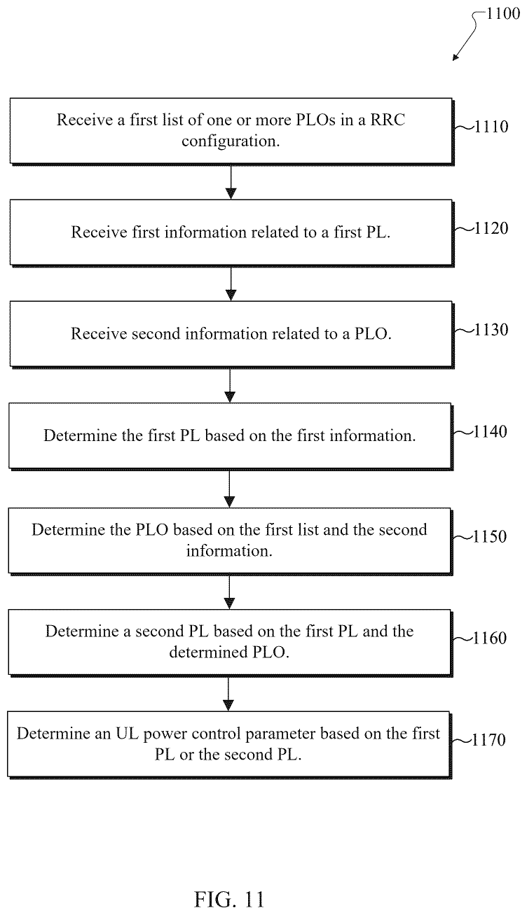

FIG. 11 illustrates an example method 1100 performed by a UE in a wireless communication system according to embodiments of the present disclosure. The method 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

The method begins with the UE receiving a first list of one or more PLOs in a RRC configuration (1110). The UE then receives first information related to a first PL (1120). For example, in 1120, the first information includes at least a PL RS index. In various embodiments, the first information includes an indicator, the first information is received in a TCI state, and the TCI state corresponds to a joint or DL TCI state. For example, when the indicator is set to ‘enabled’, the UE determines the first PL based on the PL RS index.

The UE then receives second information related to a PLO (1130). For example, in 1130, the second information includes an index pointing to an entry of the first list and the determined PLO corresponds to the entry of the first list the second information is received in a TCI state that corresponds to a joint or UL TCI state. In various embodiments, the second information comprises an index pointing to an entry of the second list, the determined PLO corresponds to the entry of the second list, the second information is received in a TCI state, and the TCI state corresponds to a joint or UL TCI state.

The UE then determines the first PL based on the first information (1140). The UE then determines the PLO based on the first list and the second information (1150). The UE then determines a second PL based on the first PL and the determined PLO (1160). In various embodiments, the first information includes an indicator that, when set to ‘1’ or ‘positive’, the UE determines the second PL as the first PL plus the PLO and, when set to ‘0’ or ‘negative’, the UE determines the second PL as the first PL minus the PLO. The UE then determines an UL power control parameter based on the first PL or the second PL (1170).

In various embodiments, the UE receives a PLO activation or deactivation MAC CE command providing one or more candidate PLOs and updates the first list of the one or more PLOs with the one or more candidate PLOs or updates the determined PLO with the one or more candidate PLOs.

In various embodiments, the UE receives a PLO sub-selection MAC CE command providing a bitmap and determines a second list of one or more PLOs based on the first list and the bitmap.

For the design examples/procedures and embodiments described or specified throughout the present disclosure, the first and second SRS resource sets, when/if configured and/or applicable, could be replaced by/with first and second CORESETs associated/configured with coresetPoolIndex values 0 and 1 (if configured/provided in PDCCH-Config for respective CORESETs) and/or associated/configured with coresetGroupIndex values 0 and 1 (if configured/provided in PDCCH-Config for respective CORESETs). In addition, throughout the present disclosure, a PLO(s) sub-selection MAC CE command could also be referred to as a PLO(s) activation/deactivation MAC CE command or a PLO(s) update MAC CE command.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive, in a radio resource control (RRC) configuration, a first list of one or more path-loss offsets (PLOs);
receive first information related to a first path-loss (PL); and
receive second information related to a PLO; and
a processor operably coupled with the transceiver, the processor configured to:
determine the first PL based on the first information;
determine, based on the first list and the second information, the PLO;
determine, based on the first PL and the determined PLO, a second PL; and
determine, based on the first PL or the second PL, an uplink (UL) power control parameter,
wherein the first information includes at least a PL reference signal (RS) index.

2. The UE of claim 1, wherein:
the first information includes an indicator,
the transceiver is further configured to receive the first information in a transmission configuration indication (TCI) state,
the TCI state corresponds to a joint or downlink (DL) TCI state, and
when the indicator is set to ‘enabled’, the processor is further configured to determine the first PL based on the PL RS index.

3. The UE of claim 1, wherein:
the second information includes an index pointing to an entry of the first list,
the determined PLO corresponds to the entry of the first list,
the transceiver is further configured to receive the second information in a transmission configuration indication (TCI) state, and
the TCI state corresponds to a joint or UL TCI state.

4. The UE of claim 1, wherein:
the transceiver is further configured to receive a PLO activation or deactivation medium access control (MAC) control element (CE) command providing one or more candidate PLOs; and
the processor is further configured to:
update the first list of the one or more PLOs with the one or more candidate PLOs; or
update the determined PLO with the one or more candidate PLOs.

5. The UE of claim 1, wherein:
the transceiver is further configured to receive a PLO sub-selection medium access control (MAC) control element (CE) command providing a bitmap; and
the processor is further configured to determine, based on the first list and the bitmap, a second list of one or more PLOs.

6. The UE of claim 5, wherein:
the second information comprises an index pointing to an entry of the second list,
the determined PLO corresponds to the entry of the second list,
the transceiver is further configured to receive the second information in a transmission configuration indication (TCI) state, and
the TCI state corresponds to a joint or UL TCI state.

7. The UE of claim 1, wherein:
the first information includes an indicator;
when the indicator is set to ‘1’ or ‘positive’, the processor is further configured to determine the second PL as the first PL plus the PLO; and
when the indicator is set to ‘0’ or ‘negative’, the processor is further configured to determine the second PL as the first PL minus the PLO.

8. A base station (BS), comprising:
a processor; and
a transceiver operably coupled with the processor, the transceiver configured to:
transmit, in a radio resource control (RRC) configuration, a first list of one or more path-loss offsets (PLOs);
transmit first information related to a first path-loss (PL); and
transmit second information related to a PLO,
wherein the first PL is based on the first information,
wherein the PLO is based on the first list and the second information,
wherein a second PL is based on the first PL and the PLO,
wherein an uplink (UL) power control parameter is based on the first PL or the second PL, and
wherein the first information includes at least a PL reference signal (RS) index.

9. The BS of claim 8, wherein:
the first information includes an indicator,
the transceiver is further configured to transmit the first information in a transmission configuration indication (TCI) state,
the TCI state corresponds to a joint or downlink (DL) TCI state, and
when the indicator is set to ‘enabled’, the first PL is based on the PL RS index.

10. The BS of claim 8, wherein:
the second information includes an index pointing to an entry of the first list,
the PLO corresponds to the entry of the first list,
the transceiver is further configured to transmit the second information in a transmission configuration indication (TCI) state, and
the TCI state corresponds to a joint or UL TCI state.

11. The BS of claim 8, wherein:
the transceiver is further configured to transmit a PLO activation or deactivation medium access control (MAC) control element (CE) command providing one or more candidate PLOs; and
one of:
the first list of the one or more PLOs is updated with the one or more candidate PLOs; or
the PLO is updated with the one or more candidate PLOs.

12. The BS of claim 8, wherein:
the transceiver is further configured to transmit a PLO sub-selection medium access control (MAC) control element (CE) command providing a bitmap; and
the first list and the bitmap indicate information for a second list of one or more PLOs.

13. The BS of claim 12, wherein:
the second information comprises an index pointing to an entry of the second list,
the PLO corresponds to the entry of the second list,
the transceiver is further configured to transmit the second information in a transmission configuration indication (TCI) state, and
the TCI state corresponds to a joint or UL TCI state.

14. The BS of claim 8, wherein:
the first information includes an indicator;
when the indicator is set to ‘1’ or ‘positive’, the second PL is the first PL plus the PLO; and
when the indicator is set to ‘0’ or ‘negative’, the second PL is the first PL minus the PLO.

15. A method performed by a user equipment (UE), the method comprising:
receiving, in a radio resource control (RRC) configuration, a first list of one or more path-loss offsets (PLOs);
receiving first information related to a first path-loss (PL);
receiving second information related to a PLO;
determining the first PL based on the first information;
determining, based on the first list and the second information, the PLO;
determining, based on the first PL and the determined PLO, a second PL; and
determining, based on the first PL or the second PL, an uplink (UL) power control parameter,
wherein the first information includes at least a PL reference signal (RS) index.

16. The method of claim 15, wherein:
the first information includes an indicator,
receiving first information further comprises receiving the first information in a transmission configuration indication (TCI) state,
the TCI state corresponds to a joint or downlink (DL) TCI state, and
determining the first PL further comprises, when the indicator is set to ‘enabled’, determining the first PL based on the PL RS index.

17. The method of claim 15, wherein:
the second information includes an index pointing to an entry of the first list,
the determined PLO corresponds to the entry of the first list,
receiving first information further comprises receiving the second information in a transmission configuration indication (TCI) state, and
the TCI state corresponds to a joint or UL TCI state.

18. The method of claim 15, further comprising:
receiving a PLO activation or deactivation medium access control (MAC) control element (CE) command providing one or more candidate PLOs; and
one of:
updating the first list of the one or more PLOs with the one or more candidate PLOs; or
updating the determined PLO with the one or more candidate PLOs.

19. The method of claim 15, further comprising:
receiving a PLO sub-selection medium access control (MAC) control element (CE) command providing a bitmap; and
determining, based on the first list and the bitmap, a second list of one or more PLOs.

20. The method of claim 19, wherein:
the second information comprises an index pointing to an entry of the second list,
the determined PLO corresponds to the entry of the second list,
the second information is received in a transmission configuration indication (TCI) state, and
the TCI state corresponds to a joint or UL TCI state.
